(19) United States
(12) Patent Application Publication
(10) Pub. No.: US 2013/0073463 A1
(43) Pub. Date: Mar. 21, 2013

(54) ISSUER TRUSTED PARTY SYSTEM

(71) Applicants: James Dimmick, Foster City, CA (US); Ben Dominguez, San Bruno, CA (US)

(72) Inventors: James Dimmick, Foster City, CA (US); Ben Dominguez, San Bruno, CA (US)

(21) Appl. No.: 13/622,993

(22) Filed: Sep. 19, 2012

Related U.S. Application Data
(60) Provisional application No. 61/536,509, filed on Sep. 19, 2011.
(60) Provisional application No. 61/570,236, filed on Dec. 13, 2011.
(60) Provisional application No. 61/598,287, filed on Feb. 13, 2012.

(51) Int. Cl. G06Q 20/40; G06F 21/00

(52) U.S. Cl. 705/44; 726/3

(57) ABSTRACT

Embodiments of the invention are directed to an authentication platform capable of storing authentication data received from an issuer access control server. The authentication platform can authenticate users and portable devices, on behalf of the issuer access control server, using the stored authentication data. Messaging extensions are included in transaction messaging indicating the authentication platform's status as an issuer trusted party, allowing the issuer access control server computer to rely on the authentication platform to conduct authentication processing.

### CROSS-REFERENCES TO RELATED APPLICATIONS

This application is a non-provisional application of and claims the benefit of priority of U.S. Provisional Application No. 61/536,509, filed on Sep. 19, 2011, U.S. Provisional Application No. 61/570,236, filed on Dec. 13, 2011, and U.S. Provisional Application No. 61/598,287, filed on Feb. 13, 2012, which are all herein incorporated by reference in their entirety for all purposes.

### BACKGROUND

Consumers are increasingly conducting transactions using portable devices (e.g. mobile phones) rather than with payment cards (e.g. credit cards, debit cards, stored value cards) and banknotes with set monetary values. As the methods of conducting transactions has increasingly shifted towards the use of portable devices, the need for methods of conducting transactions and authenticating consumers using portable devices has correspondingly increased. In addition, the need for methods of conducting transactions and authenticating consumers that can leverage less sophisticated portable device technology has increased. While sophisticated mobile phones (e.g. smartphones) can be used to access and conduct transactions over the Internet, non-smartphones have limitations in their abilities.

Meanwhile, in developing countries, while the infrastructure for mobile phones may exist, the infrastructure may not exist for transaction schemes utilizing payment cards. Users in developing countries may primarily rely on in-person cash transactions when conducting transactions for goods and services. For example, instituting a comprehensive network for the use of payment cards would require the distribution of payment cards to a significant number of users, as well as the distribution of equipment to merchants and vendors in order to process transactions using payments, such as point-of-sale terminals, payment card readers, and other computational devices. Thus, even users with payment cards and payment accounts may not be able to easily conduct transactions with merchants who do not have all the equipment necessary to process in-person transactions using payment cards.

Currently, during a transaction, user authentication data is often transmitted in messages between the parties of the transaction, including, but not limited to, a user portable device, a merchant computer, an acquirer computer, an payment processing network, and an issuer computer. Although the user authentication data is being received and transmitted by these parties, the user authentication data is not being leveraged in any way.

One limitation of the current method is that it may utilize considerable network resources and bandwidth in order to transmit user authentication data to verify the user. This may be the case despite the fact that the user authentication data may already be stored and verified by multiple parties to the transaction from previous transactions.

Thus, new and enhanced methods of utilizing existing mobile phone and network infrastructure, and the reliability of parties to a transaction, for user authentication and transaction processing has become necessary to conserve network resources and to provide greater user access to merchant services.

Embodiments of the invention address the above problems, and other problems, individually and collectively.

### BRIEF SUMMARY

Embodiments of the present invention are related to systems and methods for verifying the authenticity of a user and a portable device presented in a financial transaction through an authentication platform that is treated as an issuer trusted party by an issuer. Embodiments are further related to processing payment authorizations using the authentication platform.

In some scenarios, the merchant computer may be in a trusted relationship with the issuer computer based on reliability and previous transaction history. Where the merchant computer is trusted by the issuer computer, authentication and transaction processes may be conducted in a manner that avoids redundant procedures that can further lead to expenditure of unnecessary resources.

One embodiment of the invention is directed to a method comprising receiving at an authentication platform a transaction initiation request from a portable device operated by a user, wherein the authentication platform was previously verified as an issuer trusted party. The method may further comprise initiating an authentication process by the authentication platform and initiating a payment authorization process by the authentication platform.

Another embodiment of the invention is directed to a server computer comprising a processor, and a computer readable medium coupled to the processor, the computer readable medium comprising code for implementing a method. The method comprises receiving at an authentication platform a transaction initiation request from a portable device operated by a user, wherein the authentication platform was previously verified as an issuer trusted party. The method may further comprise initiating an authentication process by the authentication platform and initiating a payment authorization process by the authentication platform.

Another embodiment of the invention is directed to a method comprising receiving, from an authentication platform, a verify enrollment request message. The method may further comprise the issuer computer evaluating the verify enrollment request message, and generating a verify enrollment response message in response to the evaluation of the verify enrollment request message. The verify enrollment response message further comprises a request for user authentication data. The method may further comprise receiving, from the authentication platform, a payer authentication request message comprising the requested user authentication data, and verifying the user authentication data against database user authentication data.

Another embodiment of the invention is directed to a server computer comprising a processor, and a computer readable medium coupled to the processor, the computer readable medium comprising code for implementing a method. The method comprises receiving, from an authentication platform, a verify enrollment request message. The method may further comprise the issuer computer evaluating the verify enrollment request message, and generating a verify enrollment response message in response to the evaluation of the verify enrollment request message. The verify enrollment response message further comprises a request for user authentication data. The method may further comprise receiving, from the authentication platform, a payer authentication request message comprising the requested user authentication data, and verifying the user authentication data against database user authentication data.

Another embodiment of the invention is directed to a method comprising receiving, from an authentication platform, a verify enrollment request message. The method further comprises evaluating, by the issuer computer, the verify enrollment request message, and generating a verify enrollment response message in response to the evaluation of the verify enrollment request message, wherein the verify enrollment response message further comprises data relating to an authentication process used by the issuer computer. The method further comprises sending the verify enrollment response message to the authentication platform.

Another embodiment of the invention is directed to a server computer comprising a processor and a computer readable medium coupled to the processor, the computer readable medium comprising code, executable by the processor for implementing a method. The method comprises receiving, from an authentication platform, a verify enrollment request message. The method further comprises evaluating, by the issuer computer, the verify enrollment request message, and generating a verify enrollment response message in response to the evaluation of the verify enrollment request message, wherein the verify enrollment response message further comprises data relating to an authentication process used by the issuer computer. The method further comprises sending the verify enrollment response message to the authentication platform.

These and other embodiments of the invention are described in further detail below with reference to the Figures and the Detailed Description.

### BRIEF DESCRIPTION OF THE DRAWINGS

FIG. 1 shows a system diagram of a system according to an embodiment of the claimed invention.

FIG. 2 illustrates a flowchart describing the process of registering a portable device for enrollment through a system according to an embodiment of the invention.

FIG. 3 illustrates a flowchart describing the process of authenticating a user through a system according to an embodiment of the invention.

FIG. 4 illustrates a flowchart describing the process of authenticating a user via an authentication platform according to an embodiment of the invention.

FIG. 5 illustrates a flowchart describing the process of authorizing a payment for a transaction through a system according to an embodiment of the invention.

FIG. 6 illustrates a flowchart describing the clearing and settlement process using a system according to an embodiment of the invention

FIG. 7 illustrates a sequence diagram describing the process of registering a portable device for enrollment through a system according to an embodiment of the invention.

FIG. 8 illustrates a sequence diagram describing the process of topping up a portable device through a system according to an embodiment of the invention.

FIGS. 9A-9C show a depiction of an interface with an authentication platform using a portable device according to an embodiment of the invention.

FIGS. 10A-10G show a depiction of the process of topping up a portable device through an interface with an authentication platform using a portable device according to an embodiment of the invention.

FIGS. 11A-11I show a depiction of the process of conducting a bill payment through an interface with an authentication platform using a portable device according to an embodiment of the invention.

FIGS. 12A-12H show a depiction of the process of sending monetary funds between portable devices through an interface with an authentication platform using a portable device according to an embodiment of the invention.

FIG. 13 shows a block diagram of components of an authentication platform according to an embodiment of the invention.

FIG. 14 shows a block diagram of a portable device according to an embodiment of the invention.

FIG. 15 shows a block diagram of a computer apparatus according to an embodiment of the invention.

### DETAILED DESCRIPTION

Prior to discussing embodiments of the invention, descriptions of some terms may be helpful in understanding embodiments of the invention.

The term “authentication platform” may refer to a system that performs an authentication function. The authentication platform may conduct processes related to authenticating a portable device and processing transactions. In some embodiments, the authentication platform can be accessed by a user using a portable device. In such embodiments, the authentication platform can uniquely identify the portable device and provide aggregated merchant services to the user's portable device on behalf of one or more merchants or merchant systems. The authentication platform can authenticate users and portable devices on behalf of an issuer access control server computer, can generate, send, and receive authentication messages, and can generate, send, and receive authorization messages related to a transaction. An authentication platform may include a powerful computer or cluster of computers. For example, the authentication platform can be a large mainframe, a minicomputer cluster, or a group of servers functioning as a unit. The authentication platform may be coupled to a database and may include any hardware, software, other logic, or combination of the preceding for servicing the requests from one or more user device, issuer systems and payment processing networks. The authentication platform may comprise one or more computational apparatuses and may use any of a variety of computing structures, arrangements, and compilations for servicing the requests from one or more user device, issuer systems and payment processing networks.

The term “transaction initiation request” may include a message that initiates a transaction. The transaction initiation request may be a message initiated by the consumer using their portable device that is sent to the authentication platform. The transaction initiation request may be a request to transfer value between two users (e.g. individuals or entities). A typical transaction, as contemplated by embodiments of the claimed invention, involves an individual or entity purchasing goods or services from a merchant in exchange for monetary funds.

The term “portable device” may refer to a user device that is used to conduct a transaction. The portable device may be capable of conducting communications over a network. A portable device may be in any suitable form. For example, suitable portable devices can be hand-held and compact so that it can fit into a user's wallet and/or pocket (e.g., pocket-sized). The portable device can include a processor, and memory, input devices, and output devices, operatively coupled to the processor. Specific examples of portable devices include cellular or mobile phones, personal digital assistants (PDAs), pagers, portable computers, smart cards, and the like. The first payment devices can also be debit devices (e.g., a debit card), credit devices (e.g., a credit card), or stored value devices (e.g., a pre-paid or stored value card).

The term “user” may refer to an individual or entity. The user may be a consumer or business who is associated with a financial account and whose financial account can be used to conduct financial transactions using a portable device associated with the financial account.

The term “issuer trusted party” may refer to a party to a transaction that is issuer trusted. In some embodiments, an issuer trusted party may be a merchant. In some embodiments, a party may be considered “issuer trusted” based upon criteria established by an issuer. For example, a party may be “issuer trusted” if the party enrolls in a program with the issuer, if the party meets a threshold established by the issuer for “trusted party” designation, and/or by a fee given to the issuer. Other embodiments may include other methods of being designated an issuer trusted party.

The term “previously verified as an issuer trusted party” may refer to a status of a party to a transaction. In some embodiments, in order to be verified as an issuer trusted party, a party (e.g. an authentication platform, a merchant, a payment processing network) may be required to enroll in a program, or meet criteria established by an issuer. Once a party has been designated as an “issuer trusted party” by the issuer, they may be considered verified by the issuer, and thus transactions conducted with the issuer trusted party do not require further verification. In some embodiments, even when a party has been verified as an issuer trusted party, the issuer may require additional verification of transactions conducted with the issuer trusted party.

The term “initiating” may refer to either the first steps taken in order to begin a process or the steps conducted in order to complete a process. For example, “initiating an authentication process by the authentication platform” can refer to the actual process required to authenticate a portable device used in the transaction. However, “initiating an authentication process by the authentication platform” can also refer to the process of sending a message from the authentication platform to the issuer access control server computer with instructions for authenticating a portable device.

The term “authentication process” may refer to a process involving authentication. In some embodiments, an authentication process may refer to the process of authenticating a user, or a method of payment provided by the user. The authentication process may involve the generation, transmission, reception, and evaluation of authentication messages by parties in the transaction.

The term “payment authorization process” may refer to a process of authorizing a payment. In some embodiments, a payment authorization process may refer to the process of authorizing a form of payment presented by a user. The payment authorization process may involve the generation, transmission, reception, and evaluation of authorization messages by parties in the transaction. The payment authorization process may further involve evaluating user, merchant, or authentication platform credentials, as well as evaluating account information related to the payment method presented in the transaction. The typical payment authorization process results in either an approval or denial of a transaction.

The term “portable device authentication data” may refer to data that may be used to authenticate the portable device. In some embodiments, when the user communicates with the authentication platform using their portable device, the authentication platform may receive portable device authentication data that can be used to uniquely identify the portable device. For example, the authentication platform may receive the portable device's MSISDN, or Mobile Subscriber Integrated Services Digital Network-Number, which is a number that uniquely identifies a subscription in a mobile network. The MSISDN may be a phone number associated with a SIM card in a portable device in the form of a mobile telephone.

The term “registration status” may refer to the status of a user or portable device registration. In some embodiments, the authentication platform contains data as to the registration status of a portable device. In other embodiments, the registration status is also stored in an issuer access control server computer that is queried by the authentication platform. In some embodiments, prior to initiating an enrollment process, the registration status for the user device may be designated “not activated,” during an enrollment process, the registration status for the user device may be designated “pending,” and following successful enrollment, the registration status for the user device may be designated “activated.”

The term “password request message” may include a message sent as part of an authentication process for a financial transaction. In some embodiments, the password request message is transmitted from the authentication platform to the portable device of the user. The password request message may contain a request from the authentication platform for the user to submit a previously created unique password in order to begin transaction processing or services. The password request message may also contain a request from the authentication platform for the user to create or choose a unique password for the portable device as part of a user enrollment process. The password request message may be generated and sent prior to or after allowing users to access merchant goods and services through the authentication platform.

The term “password response message” may include a message sent as part of an authentication process for a financial transaction. In some embodiments, the password response message is transmitted from the portable device of the user to the authentication platform. The password response message may contain a response from the portable device to the authentication platform comprising a previously created unique password in order to begin transaction processing or services. The password response message may also contain a response from the portable device to the authentication platform comprising a unique password for the portable device to be used as part of a user enrollment process. The password response message may be generated and sent prior to or after selecting merchant goods or services for the transaction.

The term “password” may refer to a unique expression that uniquely identifies a user. The password may be created by the user and submitted via a portable device to the authentication platform. In other embodiments, the password could be created by the authentication platform on behalf of the user. The password may be alphanumeric, or composed of only numbers or only letters. Passwords are not limited to strings of characters.

The password may be an example of a “user identifier”. Other examples of user identifiers comprise a personal identification number (PIN), a unique visual image or pattern, a voice pattern, or another unique configuration of letters and/or numbers. Embodiments of the invention may use user identifier request messages and user identifier response messages.

The term “token” may include data relating to an indication of a particular status. In some embodiments, the verify enrollment request message sent from the authentication platform to the issuer computer or system may comprise a token indicating that the authentication platform is an issuer trusted party. For example, an extension in the verify enrollment request message may contain a field that uniquely identifies the authentication platform as an issuer trusted party (ITP). The field may be comprised of characters representing an ITP credential. Other embodiments contemplate the token being in other appropriate forms beyond a message extension, but that can be transmitted from the authentication platform to the issuer computer or system. The token can be evaluated by the issuer access control server computer in the authentication process to determine that the authentication platform is an issuer trusted party and thus can conduct authentication processes.

The term “verify enrollment request message” may include a message sent as part of an authentication process for a financial transaction. It may be a message that is sent from an authentication platform requesting that an issuer computer or system to verify the enrollment of an account. The verify enrollment request message may further comprise a portion indicating to the issuer computer or system that the transaction is being routed between the merchant computer and the issuer computer via a direct connection, in addition to indicating the method by which the transaction is being initiated (e.g. by interactive voice response, short messaging service, issuer trusted party, etc.). A verify enrollment request message may comply with ISO 8583, which is a standard for systems that exchange electronic transactions made by users using portable devices. A verify enrollment request message according to other embodiments may comply with other suitable standards.

The term “verify enrollment response message” may include a message sent as part of an authentication process for a financial transaction. It may be a message that is sent from an issuer computer or system in response to a verify enrollment request message sent from an authentication platform to indicate the result of the verification. The verify enrollment response message may further comprise a request from the issuer computer or system for additional user authentication data and/or authentication data for the authentication platform. The verify enrollment response message may also include a portion or extension showing the status of the authentication platform as an issuer trusted party. A verify enrollment response message may comply with ISO 8583, which is a standard for systems that exchange electronic transactions made by users using payment devices. A verify enrollment response message according to other embodiments may comply with other suitable standards.

In other embodiments, the verify enrollment response message may also comprise data relating to an authentication process used by the issuer computer. For example, the verify enrollment response message may indicate the type of authentication process used by the issuer computer. The data relating to the authentication process used by the issuer computer may also comprise data type of messaging, type of encryption, and type of data required for the authentication process.

The term “user authentication data” may refer to data used to authenticate a user. User authentication data may include data that is input by a user through a portable device in communication with an authentication platform. In some embodiments user authentication data may include, but is not limited to, account number, user date of birth, user password, user social security number. The user authentication data may also comprise of data authenticating the authentication platform, such as a unique identifier for the authentication platform. The user authentication data is transmitted from the authentication platform to the issuer system and may be compared against database user authentication data.

The term “database user authentication data” may refer to data used to authenticate a user that is stored in a database. In some embodiments, an issuer system may receive user authentication data from the user through the portable device and authentication platform. The received user authentication data may be compared against user authentication data stored in the database at the issuer system. The database user authentication data is compared to determine the authenticity of the user, the portable device, and/or the authentication platform.

The term “payer authentication request message” may include a message sent as part of an authentication process for a financial transaction. In some embodiments of the invention, a payer authentication request message may include, among other data, user authentication data that may be used to authenticate the user. The payer authentication request message may also comprise additional data provided by the authentication platform to authenticate the authentication platform as an issuer trusted party. Typically, a payer authentication request message is generated by a server computer at an authentication platform (if the transaction is an e-commerce transaction or card-not-present transaction). In other embodiments, the payer authentication request message may be generated by a merchant computer or by a Point of Sale (POS) device (if the transaction is a brick and mortar type transaction or card-present transaction).

The term “payer authentication response message” may include a message sent as part of an authentication process for a financial transaction. It may be a message that is sent from an issuer computer or system in response to a payer authentication request message sent from an authentication platform. The payer authentication response message may comprise data indicating whether the payer authentication process was successful, failed, could not be performed, unknown or other status.

The term “issuer computer” may refer to a party to a financial transaction. An issuer computer is typically a business entity (e.g. a bank) which maintains financial accounts for a plurality of users. The issuer computer can generate initial verification response messages, verify enrollment response messages, and payer authentication response messages as party of an authentication process for a user and a transaction. An issuer computer may also be referred to as an authorization system.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

### I. SYSTEMS

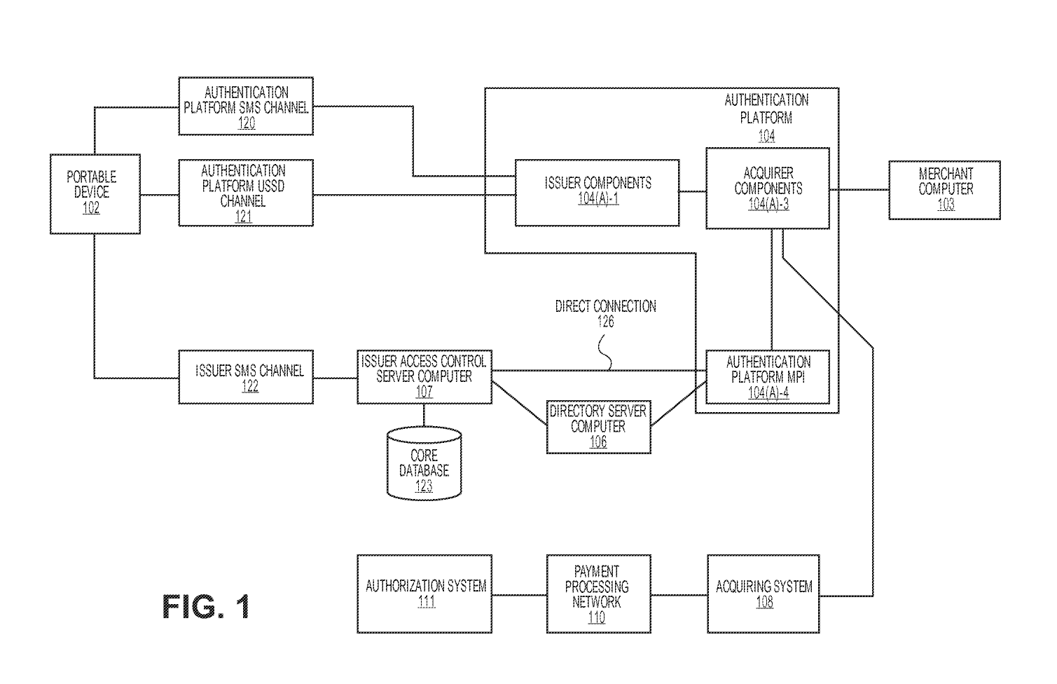

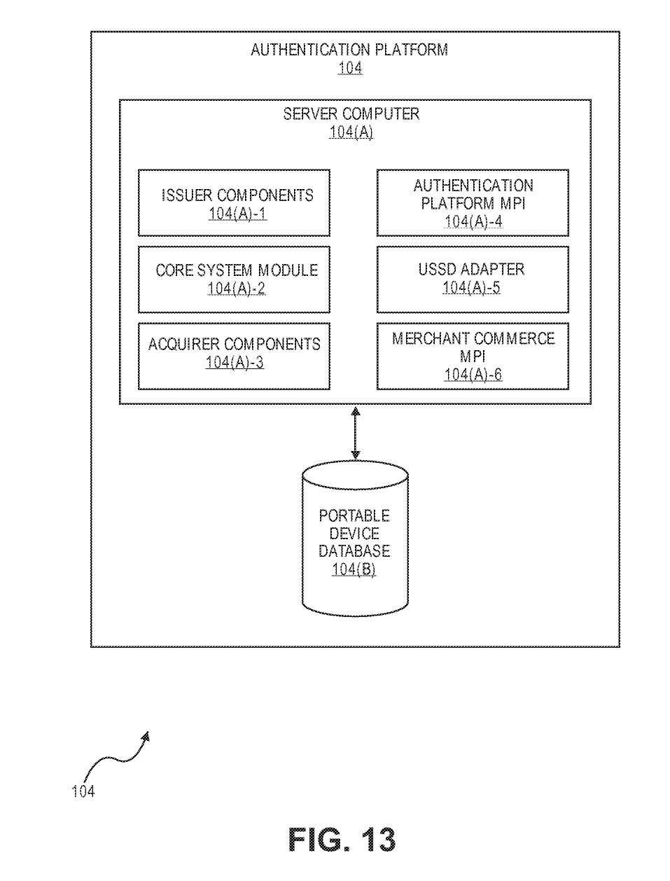

A system 100 for conducting and processing transactions according to an embodiment of the present invention is shown with reference to FIGS. 1 and 13.

The system 100 is comprised of a portable device 102 that can communicate with an issuer access control server computer 107 connected to a core database 123 by an issuer SMS channel 122. The portable device 102 may also communicate with an authentication platform 104 via an authentication platform SMS channel 120, and an authentication platform USSD channel 121. The authentication platform 104 may be comprised of issuer components 104(A)-1, acquirer components 104(A)-3, and an authentication platform MPI 104(A)-4. Additional details and components are described below with respect to FIG. 13. The authentication platform 104 further communicates with a merchant computer 103, and to an authorization system 111, through an acquiring system 108 and a payment processing network 110. The authentication platform MPI 104(A)-4 can further communicate with the issuer access control server computer 107 via a directory server computer 106 or via a direct connection 126. For simplicity of illustration, a certain number of components are shown is shown in FIG. 1. It is understood, however, that embodiments of the invention may include more than one of each component. In addition, some embodiments of the invention may include fewer than all of the components shown in FIG. 1. In addition, the components in FIG. 1 may communicate via any suitable communication medium (including the Internet), using any suitable communication protocol.

In some embodiments, the system 100 is comprised of an issuer domain, an interoperability domain, and an acquirer domain. The issuer domain describes components that can be controlled by the issuer. Typically, the issuer domain may be comprised of the portable device 102, the issuer access control server computer 107 connected to the core database 123, the authorization system 111, the authentication platform SMS channel 120, the authentication platform USSD channel 121, the issuer SMS channel 122, and the authentication platform issuer components 104(A)-1. The acquirer domain describes components that can be controlled by the acquirer. The acquirer domain may be comprised of the merchant computer 103 and the authentication platform 104. The interoperability domain describes an area where the issuer and acquirer components can interact and interoperate. In some embodiments, the interoperability domain may be comprised of the directory server computer 106 and the payment processing network 110.

The portable device 102 may be in any suitable form. For example, suitable portable devices can be hand-held and compact so that it can fit into a user's wallet and/or pocket (e.g., pocket-sized). The portable device 102 can include a processor, and memory, input devices, and output devices, operatively coupled to the processor. Specific examples of portable devices include cellular or mobile phones, personal digital assistants (PDAs), pagers, portable computers, smart cards, and other devices with messaging capabilities.

The issuer access control server computer 107 may comprise a server computer that may be configured to conduct authentication processes. The issuer access control server computer 107 may validate (or authenticate) the user and portable device in an authentication program, may perform user authentication at the time of a transaction, and may provide digitally signed responses to the authentication platform 104 through a directory server computer 106. In other embodiments, the issuer access control server computer 107 sends responses back to a merchant computer 103 directly. The issuer access control server computer 107 may also communicate with the user through the portable device 102 for authentication or registration processing via the issuer SMS channel 122.

The core database 123 may be a database connected to the issuer access control server computer 107 that can be accessed as part of the authentication process. For example, the core database 123 may store user authentication data and portable device authentication for users and portable devices 102 registered or enrolled in account authentication services.

An authorization system 111 is typically a system for a business entity (e.g. a bank) which maintains financial accounts for the user. The authorization system 111 can generate authorization response messages as part of an authorization process for a transaction. An authorization system 111 may also be referred to as an issuer computer or issuer system. An acquiring system 108 is typically a system for an entity (e.g. a bank) that has a business relationship with a particular merchant or other entity. Some entities can perform both authorization system 111 and acquiring system 108 functions. Embodiments of the invention encompass such single entity systems.

The authentication platform SMS channel 120 may be a communications channel for short message service (SMS) messages. SMS is a text-based messaging format utilized by portable devices, such as mobile phones. The authentication platform SMS channel 120 allows messaging to be communicated between the portable device 102 and the authentication platform 104 in SMS messaging format. In some embodiments, the communications are received by the authentication platform issuer components 104(A)-1. The authentication platform SMS channel 120 may be used to conduct registration processes for the user and the portable device 102, as well as to conduct transactions between the user and the authentication platform 104.

The authentication platform USSD channel 121 may be a communications channel for unstructured supplementary service data (USSD) messages. USSD is a protocol used by mobile phones for communications that are conducted over a real-time connection that remains open, which allows the two-way exchange of data. The typical format of a USSD message is an asterisk (“*”), followed by digits, and concluding with a “#” sign. The authentication platform USSD channel 121 allows messaging to be communicated between the portable device 102 and the authentication platform 104. In some embodiments, the communications are received by the authentication platform issuer components 104(A)-1. The authentication platform USSD channel 121 may be used to conduct registration processes for the user and the portable device 102, as well as to conduct transactions between the user and the authentication platform 104. Although USSD is shown, other protocols may be used in other embodiments. In some embodiments, the authentication platform USSD channel 121 may be further comprised of a USSD aggregator 121(A) that is capable of aggregating USSD messages and directing them to the appropriate destination.

The issuer SMS channel 122 may be a communications channel for short message service (SMS) messages. SMS is a text-based messaging format utilized by portable devices, such as mobile phones. The issuer SMS channel 122 allows messages to be communicated between the portable device 102 and the issuer access control server computer 107. The issuer access control server computer 107 may also communicate with the user through the portable device 102 via the issuer SMS channel 122 for authentication or registration processing. The issuer SMS channel 122 may also be used to provide the user with financial institution services.

As depicted in FIG. 13, the authentication platform 104 may have or operate at least a server computer 104(A). In some embodiments, the server computer 104(A) may be coupled to a database and may include any hardware, software, other logic, or combination of the preceding for servicing the requests from one or more client computers. The server computer 104(A) may comprise one or more computational apparatuses and may use any of a variety of computing structures, arrangements, and compilations for servicing the requests from one or more client computers.

The authentication platform 104 may be system that may conduct authentication processes on behalf of the issuer access control server computer 107 and can present merchant services to a user through a portable device 102. Components of the authentication platform 104 may also conduct transaction processing. The authentication platform 104 may be comprised of issuer components 104(A)-1, a core system module 104(A)-2, acquirer components 104(A)-3, an authentication platform MPI 104(A)-4, a USSD adapter 104(A)-5, a merchant commerce API 104(A)-6, and a portable device database 104(B).

The authentication platform issuer components 104(A)-1 can be any structural combination of hardware and software components that may be configured to conduct registration or enrollment functions. The authentication platform issuer components 104(A)-1 may also be configured to conduct authentication functions. Registration and authentication functions may comprise generating, sending, and receiving messages between the authentication platform 104 and the portable device 102. The messaging functions can be sent and received via the authentication platform SMS channel 120 or the authentication platform USSD channel 121.

The authentication platform acquirer components 104(A)-3 can be any structural combination of hardware and software components that may be configured to conduct authentication or transaction functions. The authentication platform acquirer components 104(A)-3 may communicate with the merchant computer 103 for transaction processes, including receiving list of merchant goods and services from the merchant computer 103, and receiving transaction requests from the portable device 102. The authentication platform acquirer components 104(A)-3 may also provide a connection into an authentication system and initiate authentications requests to the issuer access control server computer 107. The authentication platform acquirer components 104(A)-3 may also be configured to generate, send, and receive transaction authorization messages to an authorization system 111 through an acquiring system 108 and the payment processing network 110. The authentication platform acquirer components 104(A)-3 may also be configured to conduct reconciliation processes and dispute management.

In some embodiments, the authentication platform issuer components 104(A)-1 and the authentication platform acquirer components 104(A)-3 can be separate sets of functional components outside the authentication platform 104 that performs all of the functions described above with respect to the combined components.

The core system module 104(A)-2 may be configured to control the interactions between the authentication platform USSD channel 121, the authentication platform SMS channel 120, the merchant computer 103, and the authentication platform 104.

The authentication platform merchant server plug-in (MPI) 104(A)-4 may be a module integrated into the authentication platform 104, used to provide an interface between the authentication platform 104 and the directory server computer 106. The authentication platform MPI 104(A)-4 may verify the authorization system's 111 digital signature used to sign authentication response messages returned to the authentication platform 104. The authentication platform MPI 104(A)-4 may send verify enrollment request messages and payer authentication request messages to the issuer access control server computer 107 through the directory server computer 106. The authentication platform MPI 104(A)-4 may also receive initial verification response messages, verify enrollment response messages and payer authentication response messages from the issuer access control server computer 107 through the directory server computer 106. In some embodiments, the payer authentication request message and the payer authentication response message are transmitted between the authentication platform MPI 104(A)-4 and the issuer access control server computer 107 through the direct connection 126, bypassing the directory server computer 106.

The merchant commerce API 104(A)-6 may be an application programming interface that allows the authentication platform 104 to connect to the merchant computer 103 and/or the acquiring system 108. In some embodiments, the request may be to determine whether the user has sufficient funds in the user's account in order to complete the topping up transaction.

The portable device database 104(B) may be a database containing user and portable device authentication data. The portable device database 104(B) may be comprised of a user profile for each user and portable device. In some embodiments, the user profile may contain authentication data, including but not limited to user authentication data and portable device authentication data. The user profile in the portable device database 104(B) may also contain a record of a unique password to allow the user to conduct transactions through the authentication platform 104. The portable device database 104(B) may also allow the MSISDN to be translated into a pre-registered account number. In some embodiments, when a transaction is conducted through the authentication platform 104, the portable device database 104(B) is accessed to determine whether an MSISDN number received from the portable device 102 is activated and whether there is user authentication data in the portable device database 104(B) to conduct authentication processes on behalf of the issuer access control server computer 107.

The directory server computer 106 is a server computer that may be configured to route authentication request messages from the authentication platform 104 to the issuer access control server computer 107, as well as authentication response messages back from the issuer access control server computer 107 to the authentication platform 104. In other embodiments, the directory server computer 106 routes authentication request and response messages between the merchant computer 103 and the issuer access control server computer 107. In some embodiments, the directory server computer 106 is operated by the payment processing network 110.

The payment processing network 110 may have or operate at least a server computer. In some embodiments, the server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The payment processing network 110 may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing network 110 may use any suitable wired or wireless network, including the Internet.

The payment processing network 110 may process authorization request messages and determine the appropriate destination for the authorization request messages.

An authorization request message can be a message sent requesting that the authorization system 111 authorize a financial transaction. An authorization request message may comply with ISO 8583, which is a standard for systems that exchange electronic transactions made by users using payment devices. An authorization request message according to other embodiments may comply with other suitable standards. In some embodiments, the authorization request message may include, among other data, a Primary Account Number (PAN), user identification data, amount of the transaction, and merchant ID or merchant category. In some embodiments, an authorization request message is generated by a server computer (if the transaction is an e-commerce transaction) or a Point of Sale (POS) device (if the transaction is a brick and mortar type transaction) and is sent to the authorization system 111 via the payment processing network 110 and the acquiring system 108.

An authorization response message can be a message sent from the authorization system 111, in response to an authorization request message to either approve or decline a financial transaction. An authorization response message may comply with ISO 8583, which is a standard for systems that exchange electronic transactions made by users using payment devices.

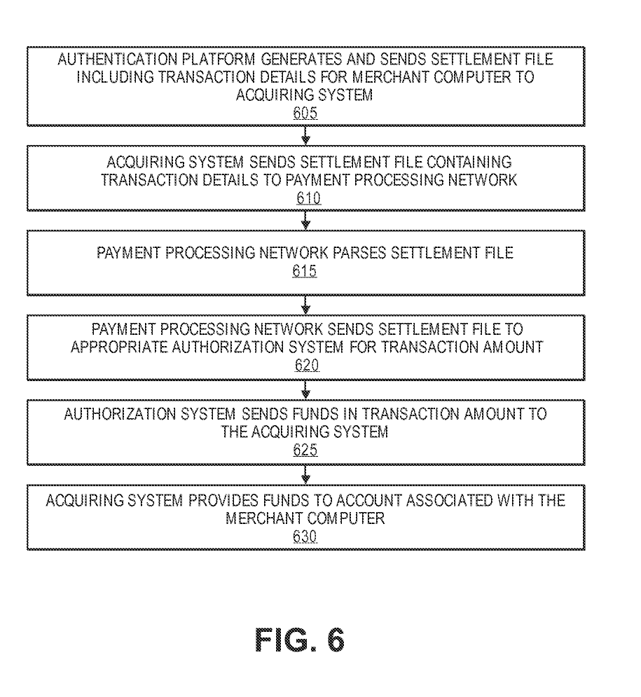

The payment processing network may also handle the clearing and settlement of transactions. The payment processing network may authenticate user information and organize the settlement process of user accounts between the acquiring system 108 and the authorization system 111. An exemplary system for clearing and settlement is the Base II data processing system, which provides clearing, settlement, and other interchange-related services. Additional details regarding the clearing and settlement process will be discussed with respect to FIG. 6.

The merchant computer 103 may be comprised of various modules that may be embodied by computer code, residing on computer readable media. It may include any suitable computational apparatus operated by a merchant. The merchant computer 103 may be in any suitable form. Examples of merchant computers include any device capable of accessing the Internet, such as a personal computer, cellular or wireless phones, personal digital assistants (PDAs), tablet PCs, and handheld specialized readers. The merchant computer 103 transmits data to the authentication platform 104, including merchant lists of goods and services that can be provided to the user through the authentication platform 104. In other embodiments of the invention, the merchant computer 103 may receive transaction data and transmit the transaction data to the payment processing network 110 for further transaction authorization processes.

### II. METHODS

Methods according to embodiments of the invention can be described with respect to FIGS. 1-13.

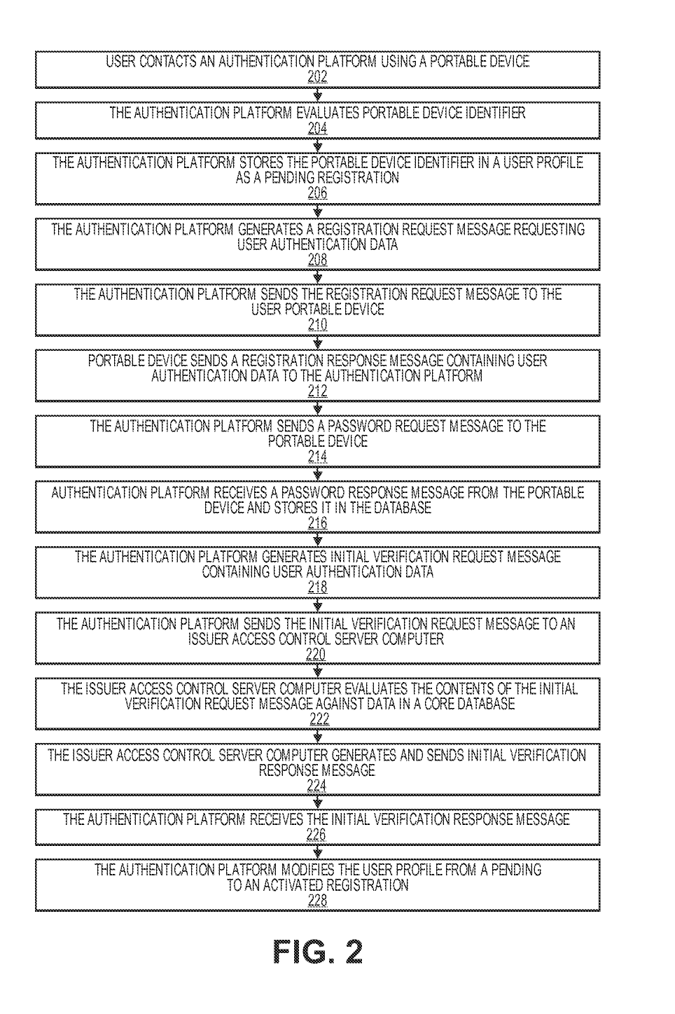

FIG. 2 is a flowchart of a method 200 for enrolling or registering a portable device 102 with an authentication platform 104 in order to conduct transactions through the system 100 shown in FIG. 1.

In step 202, the user contacts an authentication platform 104 using a portable device 102. The user can contact the authentication platform 104 via an authentication platform SMS channel 120 or an authentication platform USSD channel 121. In some embodiments, the user dials a USSD-2 number associated with the authentication platform 104 through an authentication platform USSD channel 121. In other embodiments, the user sends an SMS message to the authentication platform 104 through an authentication platform SMS channel 120. While USSD and SMS are two exemplary methods of communicating with the authentication platform 104 over a network, other modes of communication can also be utilized to conduct communications between a portable device 102 and the authentication platform 104.

In step 204, the authentication platform 104 evaluates a portable device identifier. In some embodiments, the authentication platform 104 receives a communication from the portable device 102 via the authentication platform SMS channel 120 or the authentication platform USSD channel 121. In some embodiments, the authentication platform 104 receives portable device authentication data (e.g. the portable device identifier) from the portable device 102. As the communication originated from the portable device 102, the authentication platform 104 can evaluate an MSISDN (or Mobile Subscriber Integrated Services Digital Network-Number) number associated with the portable device 102. The process of evaluating the portable device identifier may include querying a portable device database 104(B) in the authentication platform 104 with the portable device authentication data to determine current enrollment or registration status of the portable device 102.

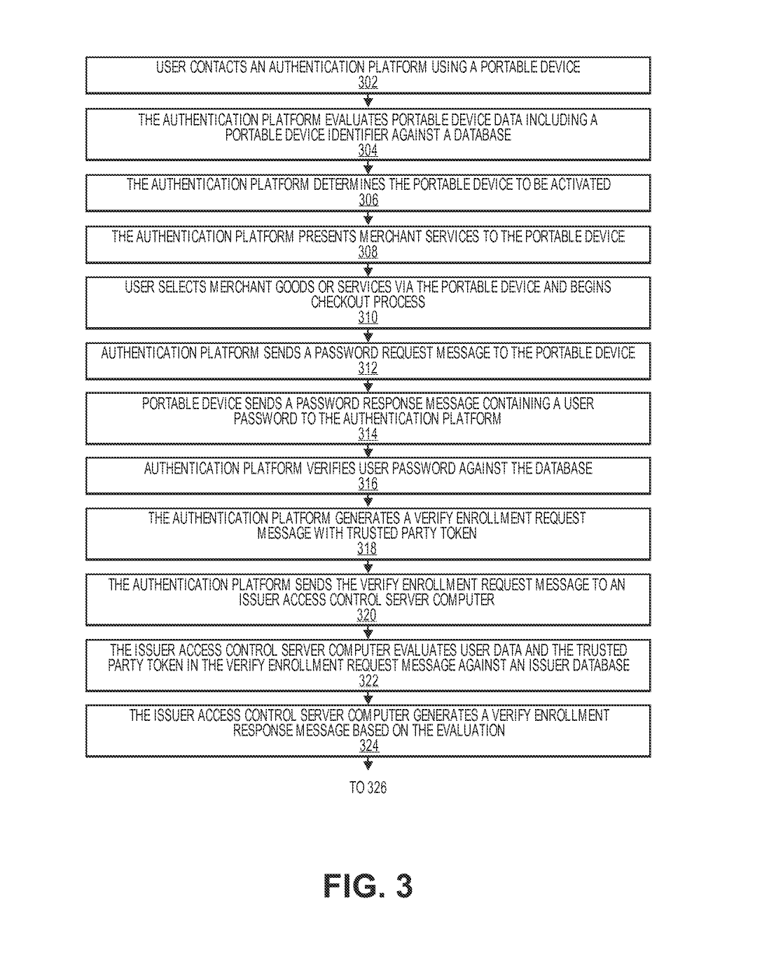

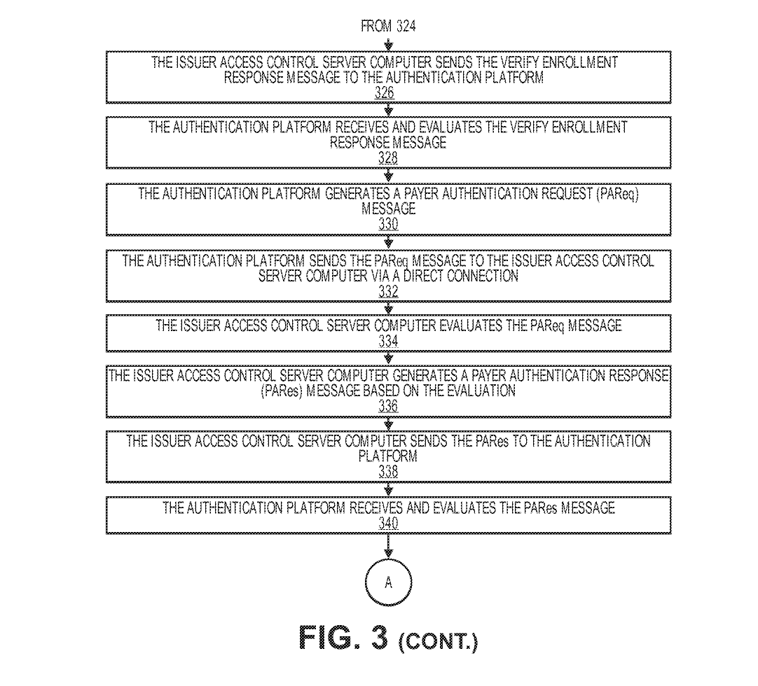

In step 206, the authentication platform 104 stores the portable device identifier in a user profile as a pending registration. In some embodiments, after evaluating the portable device identifier against the portable device database 104(B), the authentication platform 104 determines whether the portable device 102 is enrolled or registered to conduct transactions through the authentication platform 104. If the portable device 102 is not enrolled or registered, the authentication platform 104 creates a user profile in the authentication platform 104 recording that the enrollment or registration for the portable device 102 is a pending registration. If the portable device 102 is enrolled or registered, the authentication platform 104 does not take any further steps in the enrollment process, and the user can continue with conducting a transaction, as described in FIGS. 3-6.

In step 208, the authentication platform 104 generates a registration request message requesting user authentication data. In some embodiments, when the authentication platform 104 determines that the portable device 102 is not registered, the authentication platform 104 generates a registration request message. In some embodiments, the registration request message comprises a message to the user informing the user that a one-time registration process will take place. The registration request message may further comprise a request for user authentication data, including but not limited to, the user's account number, the expiration date, the user's data of birth and other data that would uniquely authenticate the user.

In step 210, the authentication platform 104 sends the registration request message to the portable device 102. In some embodiments, the authentication platform 104 sends the registration request message to the portable device 102 via SMS, USSD-2, or by any other appropriate messaging and communications means. In some embodiments, the registration request message can be sent to the portable device 102 through the authentication platform SMS channel 120 or the authentication platform USSD channel 121.

In step 212, the portable device 102 sends a registration response message containing user authentication data, to the authentication platform 104. The portable device 102 generates a registration response message containing the user authentication data requested by the authentication platform 104 in the registration request message. In some embodiments, the portable device 102 sends the registration response message to the authentication platform 104.

In step 214, the authentication platform 104 sends a password request message to the portable device 102. The authentication platform 104 generates a password request message. The password request message may comprise a request for the user to provide a unique password that will be associated with the user profile for the portable device 102 such that when the user initiates a transaction through the authentication platform 104, the user can submit the password as part of the authentication scheme.

In step 216, the authentication platform 104 receives a password response message from the portable device 102 and stores the password response message in a portable device database 104(B). The user, via the portable device 102, may create a unique password and send the unique password in a password response message to the authentication platform 104. After receiving the password response message, the authentication platform 104 may evaluate the password response message and parse out the unique password created by the user. The authentication platform 104 may then associate the unique password with the portable device 102 and the user profile stored in the portable device database 104(B).

In step 218, the authentication platform 104 generates an initial verification message containing user authentication data. The authentication platform 104 generates the initial verification message that may be comprised of, but is not limited to, the user's account number or payment device number, the portable device number, the expiration date, the user's data of birth, the trusted party token, and other data that would uniquely authenticate the user. The initial verification message is generated in order to verify the user authentication data as being authenticate.

In step 220, the authentication platform 104 sends the initial verification message to an issuer access control server computer 107. The authentication platform 104 may send the initial verification message to the issuer access control server computer 107 by any appropriate messaging means.

In step 222, the issuer access control server computer 107 evaluates the contents of the initial verification message against data in a core database 123. The issuer access control server computer 107 may receive the initial verification message from the authentication platform 104 through the director server computer 106, via the direct connection 126, or by any other appropriate messaging means. The issuer access control server computer 107 may then parse out the user authentication data contained in the initial verification message. The received user authentication data can then be compared to user authentication data stored in the core database 123. In some embodiments, as the issuer computer issued the user's account, it has stored user authentication data that can be compared against the received user authentication data in order to authenticate the enrollment/registration request.

In step 224, the issuer access control server computer 107 generates an initial verification response message and sends it to the authentication platform 104. The initial verification response message may comprise a user authentication verification value (e.g. a cardholder authentication verification value, or CAW). The initial verification response message may be a message that is sent from the issuer access control server computer 107 in response to the initial verification message sent from an authentication platform 104 in order to verify the enrollment of a portable device 102. The initial verification response message may further comprise a request from the issuer access control server computer 107 for additional user authentication data and/or authentication data for the authentication platform 104.

In step 226, the authentication platform 104 receives the initial verification response message. The authentication platform 104 may receive the initial verification response message from the issuer access control server computer 107 through a communications channel. For example, the authentication platform 104 may receive the initial verification response message through a direct connection 126 with the issuer access control server computer 107 or through the directory server computer 106.

In step 228, the authentication platform 104 modifies the user profile stored in the portable device database 104(B) from a pending registration to an activated registration. After determining that the user authentication data was authenticated by the issuer access control server computer 107, the authentication platform 104 updates the user profile associated with the portable device 102. The authentication platform 104 modifies the user profile from pending to activated, and the portable device 102 is authenticated to conduct transactions through the authentication platform 104.

Following this process, the portable device 102 is now authenticated and registered with the authentication platform 104. Thus, the portable device 102 can be used to conduct transactions through the authentication platform 104.

FIG. 3 is a flowchart of a method 300 for authenticating a portable device for conducting a transaction through an authentication platform 104 using a portable device 102 using a system 100 shown in FIG. 1. In method 300, once the authentication platform 104 has authenticated the portable device 102, even though the authentication platform 104 has been designated an issuer trusted party, additional authentication processes are conducted through the issuer control access server computer 107. In this method, although the authentication platform 104 is an issuer trusted party, the issuer control access server computer 107 is still accessed for authentication purposes. In some embodiments, this process may be for certain transactions based on criteria established by the issuer control access server computer 107 or may be a requirement for all transaction. Thus, in such embodiments, the transaction can proceed once the portable device 102 is authenticated by the authentication platform 104 and the issuer control access server computer 107.

In step 302, the user contacts an authentication platform 104 using a portable device 102. The user may contact an authentication platform to send a transaction initiation request from the portable device 102 operated by a user. The user can contact the authentication platform 104 via an authentication platform SMS channel 120 or an authentication platform USSD channel 121.

In step 304, the authentication platform 104 evaluates portable device identifier data, including a portable device identifier, against data in an authentication platform portable device database 104(B). In some embodiments, the authentication platform 104 was previously verified as an issuer trusted party by an issuer access control server computer 107. In some embodiments, the authentication platform 104 receives a communication from the portable device 102 via the authentication platform SMS channel 120 or the authentication platform USSD channel 121. As the communication originated from the portable device 102, the authentication platform 104 can evaluate an MSISDN (or Mobile Subscriber Integrated Services Digital Network-Number) number associated with the portable device 102. The process of evaluating the portable device identifier may include checking the received MSISDN number against a portable device database 104(B) in the authentication platform 104 to determine current enrollment or registration status of the portable device 102.

In step 306, the authentication platform 104 determines the portable device 102 to be activated. After evaluating the portable device identifier against the portable device database 104(B), the authentication platform 104 determines whether the registration for the portable device 102 is activated to conduct transactions through the authentication platform 104.

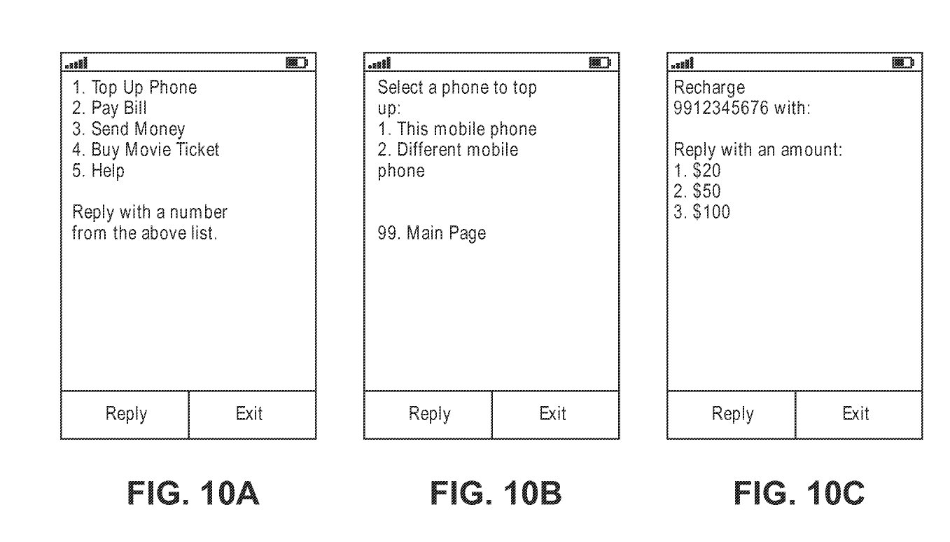

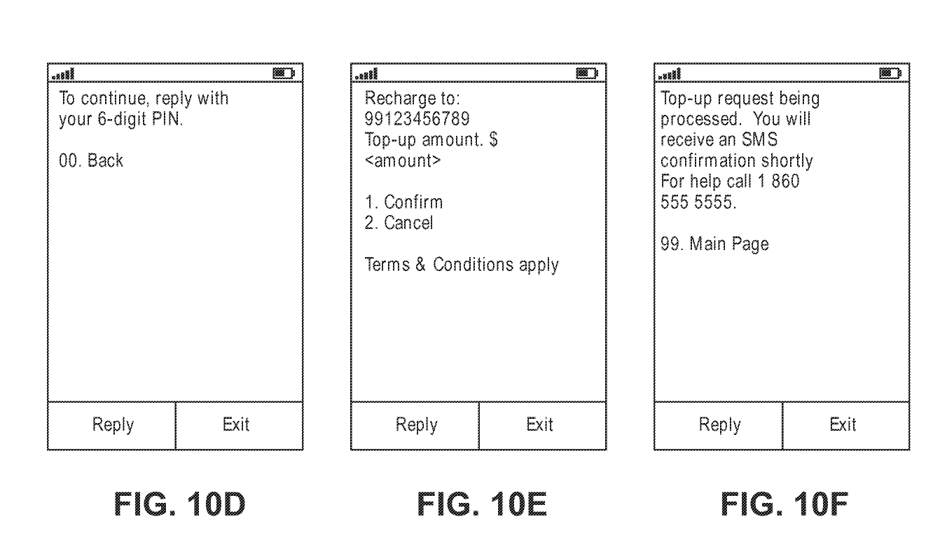

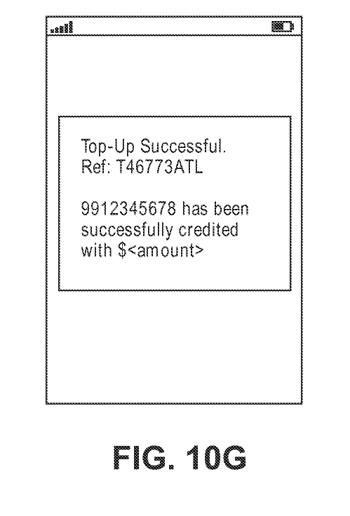

In step 308, the authentication platform 104 presents merchant services to the portable device 102. Once the authentication platform 104 has determined the portable device to be activated, the authentication platform 104 can access merchant services that are available to the user. In some embodiments, the authentication platform 104 can access a list of merchant services unique to each user based on a user profile. In other embodiments, the authentication platform 104 can access a standard list of merchant services. Examples of merchant services that may be access include, but are not limited to, topping up the portable device, topping up a different portable device, sending money to another portable device, bill payments, and purchasing of goods and services. An exemplary depiction of merchant services presented to the portable device is shown in FIG. 10C.

In some embodiments, the authentication platform 104 can access merchant services unique to each user in real-time through a connection with the merchant computer 103 that may be established when the portable device 102 contacts the authentication platform 104. In other embodiments, the authentication platform 104 may have previously retrieved merchant services from the merchant computer 103. In such embodiments, the retrieved merchant services available to each portable device 102 may be stored in the profile associated with each portable device 102 in the portable device database 104(B). The authentication platform 104 may periodically update the retrieved merchant services through period connections with the merchant computer 103.

After merchant services are accessed by the authentication platform 104, the authentication platform 104 can sends the options to the portable device 102. The merchant services can be sent to the portable device 102 using any appropriate messaging means, including SMS or USSD. In some embodiments, the merchant services can be sent to the portable device 102 through the authentication platform SMS channel 120 or the authentication platform USSD channel 121.

In step 310, the user selects merchant goods or services via the portable device 102 and begins a checkout process. As described above, a plurality of different merchant services can be presented to the user's portable device 102. The user can select the merchant services the user desires, go through the process of configuring options for the desired merchant services, and then initiate a checkout process.

In step 312, the authentication platform 104 sends a password request message to the portable device 102. The authentication platform 104 generates a password request message. The password request message may comprise a request for the user to provide the unique password that is associated with the user profile for the portable device 102 such that the user can be authenticated. In some embodiments, the password request message can be sent to the portable device 102 through the authentication platform SMS channel 120 or the authentication platform USSD channel 121.

In step 314, the portable device 102 sends a password response message containing a user password to the authentication platform 104. The authentication platform 104 receives a password response message from the portable device 102 and stores the password response message in the user profile in the portable device database 104(B). In some embodiments, the password response message can be sent to the authentication platform 104 through the authentication platform SMS channel 120 or the authentication platform USSD channel 121.

In step 316, the authentication platform 104 verifies the user password against the database data. After receiving the password response message, the authentication platform 104 may evaluate the password response message and parse out the unique password received from the user. The authentication platform 104 may then determine if the received password matches the password associated with the portable device 102 and the user profile stored in the portable device database 104(B).

In step 318, the authentication platform 104 generates a verify enrollment request message, which includes a trusted party token. The trusted party token is used to identify the authentication platform 104 as an issuer trusted party. The authentication platform 104 can generate the verify enrollment request message with a number of unique fields. The verify enrollment request message may further include user authentication data, including, but not limited to, user portable device number, user account number, and other user data. The verify enrollment request message may be a message that is sent from the authentication platform 104 requesting that an issuer access control server computer 107 to verify the enrollment of the portable device 102.

In some embodiments, the verify enrollment request message may also indicate the type of connection between the authentication platform 104 and the issuer access control server computer 107. For example, the verify enrollment request message may comprise a portion indicating to the issuer access control server computer 107 that the transaction is being routed between a merchant computer 103 and the issuer access control server computer 107 via a direct connection 126, in addition to indicating the method by which the transaction is being initiated (e.g. by interactive voice response, short messaging service, issuer trusted party, etc.). The verify enrollment request message may comply with ISO 8583, which is a standard for systems that exchange electronic transactions made by users using portable devices. The verify enrollment request message according to other embodiments may comply with other suitable standards.

Exemplary data fields in the verify enrollment request message are shown in the following table. These fields, fewer fields, or additional fields not described below may comprise the verify enrollment request message.

| Purpose | Extension Field |
|---|---|
| Portable Device Identifier Format | npc356chphoneidformat |
| (Length - 1, Alphanumeric) | |

| | |
|---|---|
| Value | Definition |
| I | Indicates that the Phone or |
| | Portable Device ID will be in |
| | International Format: |
| | CCCAAANNNNNNNNNN |
| | where |
| | CCC = Country Code |
| | AAA = Area Code |
| | NNNNNNNNNN = Subscriber |
| | Number |
| D | Indicates that the Phone or |
| | Portable Device ID will be in |
| | Domestic Format: |
| | AAANNNNNNNNNN where |
| | AAA = Area Code |
| | NNNNNNNNNN = Subscriber |
| | Number |

| | |
|---|---|
| Portable Device Identifier | npc356chphoneid |
| (Length - 1-25, Numeric digits) | |
| PAReq Channel (The payer authentication | npc356pareqchannel |
| request channel field indicates how the | |
| transaction is being routed between the | |
| authentication platform 104 and the issuer | |
| access control server computer 107 during | |
| authentication). | |
| (Length - 1-15, Alphanumeric) | |

| | |
|---|---|
| Value | Definition |
| blank | Value indicates to the ACS to |
| | assume URL redirection. |
| | Communications with the |
| | MPI/client will be using server |
| | to server communication over |
| | the internet. |
| DIRECT | Value indicates to the ACS to |
| | communicate directly with the |
| | MPI via server to server |
| | communication over the |
| | internet, avoiding URL |
| | redirection. |

| | |
|---|---|
| Shopping Channel (The shopping channel field | npc356shopchannel |
| indicates how the transaction is being initiated). | |
| (Length - 1-15, Alphanumeric) | |

| | |
|---|---|
| Value | Definition |
| IVR | Via Interactive Voice |
| | Response |
| CLIENT | Via J2ME (Java2 Micro |
| | Edition) or STK application |
| ITP | Via Issuer Trusted Party |
| SMS | Via Short Messaging Service |
| | (SMS) OR |
| | via Unstructured |
| | Supplementary Service Data |
| | (USSD) |
| WAP | Via Wireless Application |
| | Protocol |
| native-app | Other native app |

| | |
|---|---|
| Available Authentication Channels (The | npc356availauthchannel |
| available authentication channels field indicates | |
| the available mediums supported by the | |
| portable device for authentication) | |
| (Length - 1-15, Alphanumeric) | |

| | |
|---|---|
| Value | Definition |
| SMS | Via Short Messaging Service |
| IVR | Via Interactive Voice |
| | Response |
| USSD | Via Unstructured |
| | Supplementary Service Data |
| WAP | Via Wireless Application |
| | Protocol |

| | |
|---|---|
| Authentication Platform Credential (The | npc356itpcredential |
| authentication platform credential field is a | |
| value sent by the authentication platform | |
| 104 to the issuer access control server computer | |
| 107 in order to prove its relationship as an | |
| issuer trusted party) | |
| (Length - 1-80, Alphanumeric) | |

The “npc356chphoneidformat” field is a field that indicates the format of portable device identifier. In some embodiments, the “npc356chphoneidformat” field is at least one character in length. In other embodiments, the “npc356chphoneidformat” field may be of greater length. In some embodiments, the “npc356chphoneidformat” field is an alphanumeric field. It may also be composed of only numbers or only letters. The field may be used to indicate that the format of the portable device identifier will be in an international format or a domestic format. For example, when the “npc356chphoneidformat” field is “D”, the field indicates that the portable device identifier will be received in a domestic format, which may be characterized as AAANNNNNNNNNN, where “AAA” is the area code and “NNNNNNNNNN” is the subscriber number. When the “npc356chphoneidformat” field is “I”, the field indicates that the portable device identifier will be received in an international format, which may be characterized as CCCAAANNNNNNNNNN, where “CCC” is the country code.

The “npc356chphoneid” field is a field that contains the portable device identifier. In some embodiments, the “npc356chphoneidformat” field is at least one character in length. In other embodiments, the “npc356chphoneidformat” field is between 1 and 25 characters. In some embodiments, the portable device identifier contained in the field is comprised of numeric digits only. In other embodiments, the portable device identifier is comprised of alphanumeric characters, or letters. The format of the portable device identifier may be as described above with respect to the portable device identifier format field.

The “npc356pareqchannel” field is a field that may indicate how the transaction is being routed between the authentication platform 104 and the issuer access control server computer 107 during the authentication process. Examples of values for the npc356pareqchannel field is “DIRECT” or “<blank>”. In some embodiments, when the value is “DIRECT”, it may indicate to the issuer access control server computer 107 that communications with the authentication platform MPI 104(A)(4) will be conducted via server to server communication over a network, avoiding URL redirection. In such embodiments, the connection may be via the direct connection 126, as depicted in FIG. 1. In some embodiments, when the value is “<blank>”, it may indicate to the issuer access control server computer 107 that communications with the authentication platform MPI 104(A)(4) will be server to server communication over a network using URL redirection. URL redirection is an Internet technique for redirecting an inputted URL to a different URL. The value of “<blank>” may be an indication to the issuer access control server computer 107 that the transaction may have originated from a personal computer using an Internet browser.

In some embodiments, the “npc356pareqchannel” field is at least one character in length. In other embodiments, the “npc356pareqchannel” field is between 1 and 15 characters. In some embodiments, the “npc356pareqchannel” field is an alphanumeric field. It may also be composed of only numbers or only letters.

The “npc356shopchannel” field is a field that indicates how the transaction was initiated. Examples of values may include, but are not limited to, “IVR” indicating interactive voice response, “CLIENT” indicating Java2 Micro Edition (J2ME) or SIM Toolkit (STK) application, “ITP” indicating issuer trusted party, “SMS” indicating short messaging service or unstructured supplementary service data (USSD), “WAP” indicating wireless application protocol, and “native-app” indicating another application.

The “npc356shopchannel” field may indicate to the issuer access control server computer 107 that different authentication processes may be required. For example, a transaction initiated via USSD may be considered more reliable and secure than a transaction initiated via IVR because of the possibility of phone number spoofing through IVR that is not present in USSD connections.

The “npc356shopchannel” field may also indicate to the issuer access control server computer 107 how a response should be formatted. For example, “IVR” may indicate that the transaction was not initiated through HTML or an Internet browser and thus a response should not be sent over a data channel as the consumer may have initiated the transaction via a portable device 102, such as a mobile phone that is not capable of accessing data channels.

In some embodiments, the “npc356shopchannel” field is at least one character in length. In other embodiments, the “npc356shopchannel” field is between 1 and 15 characters. In some embodiments, the “npc356shopchannel” field is an alphanumeric field. It may also be composed of only numbers or only letters.

The “npc356availauthchannel” field is a field that indicates the available mediums that may be supported by the portable device 102 for authentication. Examples of values may include, but are not limited to, “SMS”, “IVR”, “USSD”, and “WAP”. The “npc356availauthchannel” field may indicate to the issuer access control server computer 107 the types of communications methods available to the portable 102. This may allow the issuer access control server computer 107 to format a response in a manner that will be appropriate for the portable 102. For example, “IVR” indicates that the portable device 102 can conduct authentication through an interactive voice response, which is typically not able to handle data.

In some embodiments, the “npc356availauthchannel” field is at least one character in length. In other embodiments, the “npc356availauthchannel” field is between 1 and 15 characters. In some embodiments, the “npc356availauthchannel” field is an alphanumeric field. It may also be composed of only numbers or only letters.

The “npc356itperedential” field is a field that contains a value sent by the authentication platform 104 to the issuer access control server computer 107 in order to authenticate the authentication platform 104 and prove that it is in a trusted relationship and is an issuer trusted party. This field is thus used to verify the authentication platform 104 as an issuer trusted party, which may provide greater reliability and trust for transactions conducted with the authentication platform 104. The “npc356itperedential” field may contain a value previously given by the issuer access control server computer 107 or chosen by the authentication platform 104.

In some embodiments, the “npc356itperedential” field is at least one character in length. In other embodiments, the “npc356itperedential” field is between 1 and 80 characters. In some embodiments, the “npc356itperedential” field is an alphanumeric field. It may also be composed of only numbers or only letters.

In step 320, the authentication platform 104 sends the verify enrollment request message to an issuer access control server computer 107. The authentication platform 104 may send the verify enrollment request message to the issuer access control server computer 107 by any appropriate messaging means across an appropriate communications means, such as a network or the Internet. In some embodiments, the authentication platform 104 sends the verify enrollment request message through a directory server computer 106 to the appropriate issuer access control server computer 107.

In step 322, the issuer access control server computer 107 evaluates user data and the trusted party token in the verify enrollment request message against data in an issuer database 123. The issuer access control server computer 107 may receive the verify enrollment request message from the authentication platform 104 via a direct connection 126. In other embodiments, the issuer access control server computer 107 receives the verify enrollment request message through a directory server computer 106.

The issuer access control server computer 107 may evaluate the credentials presented by the authentication platform 104. For example, the issuer access control server computer 107 may validate the value in the “npc356itperedential” field described above. If the credential validation is successful, the issuer access control server computer 107 may validate other data elements in the verify enrollment request message, including the user authentication data. In some embodiments, the issuer access control server computer 107 may analyze the verify enrollment request message and extract the user authentication data contained in the verify enrollment request message. The received user authentication data can then be compared to user authentication data stored in the issuer database. In some embodiments, as the issuer computer issued the user's account, it has stored user authentication data that can be compared against the received user authentication data in order to authenticate the enrollment/registration request.

In step 324, the issuer access control server computer 107 generates a verify enrollment response message based on the evaluation. In some embodiments, the verify enrollment response message may comprise a registration status of the portable device. The verify enrollment response message may comprise a user authentication verification value (e.g. a cardholder authentication verification value, or CAVV). The verify enrollment response message may be a message that is sent from the issuer access control server computer 107 in response to a verify enrollment response message sent from an authentication platform 104 in order to verify the enrollment of a portable device 102.

In other embodiments, the verify enrollment response message may also comprise data relating to an authentication process used by the issuer computer. For example, the verify enrollment response message may indicate the type of authentication process used by the issuer computer. The data relating to the authentication process used by the issuer computer may also comprise data type of messaging, type of encryption, and type of data required for the authentication process.

The verify enrollment response message from the issuer access control server computer 107 may indicate that the authentication is available. The verify enrollment response message may further comprise a request from the issuer access control server computer 107 for additional user authentication data and/or authentication data for the authentication platform 104. For example, the issuer access control server computer 107 may request additional user authentication data that is not customarily included by the authentication platform 104 in the verify enrollment request message. In some embodiments, the issuer access control server computer 107 may request additional user authentication data for a variety of reasons, such as for transactions using a less reliable or less secure communication channel, for transactions of high values, and/or for transactions involving non-issuer trusted parties.

The verify enrollment response message may also include a portion showing the status of the authentication platform 104 as an issuer trusted party. The verify enrollment response message may comply with ISO 8583, which is a standard for systems that exchange electronic transactions made by users using payment devices. The verify enrollment response message according to other embodiments may comply with other suitable standards.

Exemplary data fields in the verify enrollment response message are shown in the following table. These fields, fewer fields, or additional fields not described below may comprise the verify enrollment response message.

| Purpose | Extension Field |
|---|---|
| Authentication Data (The authentication | npc356authdata |
| data field indicates the list of user | |
| authentication data fields, which need | |
| to be captured from the user.) | |
| Authentication Data Name (The | name |
| authentication data name field | |
| specifies the data being requested by | |
| the issuer access control server 107.) | |
| (Length - 1-25, Alphanumeric) | |

| | |
|---|---|
| Value | Definition |
| SP | Static Password |
| OTP1 | One Time Password (OTP) - |
| | Issued to Cardholder Prior to |
| | Entering into Transaction |
| OTP2 | One Time Password - Issued |
| | to Cardholder During the |
| | Transaction |
| ITP | Authentication Performed by |
| | an Issuer Trusted Party |
| ICB | Issuer Call-Back |
| other | Other issuer-specific |
| | Authentication Method (e.g., |
| | “NETBANKINGPIN”) |

| | |
|---|---|
| Authentication Data Maximum Length | length |
| (The authentication data maximum | |
| length field specifies the maximum | |
| length of the data expected by the issuer | |
| access control server 107.) | |
| (Length - 1-2, Numeric) | |
| Authentication Data Type (The | type |
| authentication data type field specifies | |
| the type of the data expected by the | |
| Issuer Access Control Server.) | |
| (Length - 1, Alphanumeric) | |

| | |
|---|---|
| Value | Definition |
| A | Text |
| N | Numeric Only |

| | |
|---|---|
| Authentication Data Label (The | label |
| authentication data label field indicates | |
| the label that can be displayed on the | |
| client application.) | |
| (Length - 1-20, Alphanumeric, UTF-8) | |
| Authentication Data Prompt (The | prompt |
| authentication data prompt field can be | |
| used by the IVR clients to convert the | |
| text to voice to the end user.) | |
| (Length - 1-80 Alphanumeric, UTF-8) | |
| Examples: | |
| “Please enter OTP sent by your bank to | |
| your mobile” | |
| “Enter special code from your card | |
| issuer” | |
| ACS Status Message (The issuer access | npc356authstatusmessage |
| control server 107 status message field | |
| may be sent back to the client | |
| applications to provide additional | |
| information.) | |
| (Length - 1-40, Alphanumeric, UTF-8) | |
| Examples: | |
| “OTP has been sent to your mobile” | |
| “OTP sent to your registered phone.” | |
| Auth Data ACS Encryption (The | npc356authdataencrypt |
| authentication data ACS field indicates | |
| the data encryption key that is passed to | |
| the MPI/client. This key is used to | |
| encrypt the user authentication data | |
| before passing to the issuer access | |
| control server 107 in the payer | |
| authentication request message to the | |
| issuer access control server 107. This | |
| protects the data entered by the user | |
| from other entities through which the | |
| transaction may flow.) | |
| (This field may be used if the issuer | |
| access control server computer 107 | |
| requests a static password. If dynamic | |
| data is used for authentication, this | |
| field may be left blank or omitted.) | |
| Encryption Type (This field indicates | npc356authdataencrypttype |
| the type of encryption supported by the | |
| issuer access control server 107 [e.g. | |
| RSA].) | |
| (Length - 1-20, Alphanumeric) | |
| (This field may be used if the issuer | |
| access control server computer 107 | |
| requests a static password. If dynamic | |
| data is used for authentication, this | |
| field may be left blank or omitted.) | |
| Encryption Key Value (The encryption | npc356authdataencryptkeyValue |
| key value field indicates the actual key | |
| to be used for encrypting the user data) | |
| (Length - 1-16, Alphanumeric) | |
| (This field may be used if the issuer | |
| access control server computer 107 | |
| requests a static password. If dynamic | |
| data is used for authentication, this field | |
| may be left blank or omitted.) | |
| Issuer Trusted Party (ITP) Validation | npc356itpstatus |
| Status | |
| (Length - 2, Alphanumeric) | |

| | |
|---|---|
| Value | Definition |
| 01 | Invalid credential for ITP. |
| 02 | Invalid key for ITP. |
| 03 | ITP credential expired or |
| | revoked. |
| 04 | Invalid syntax |
| 90 | User phone/PAN invalid |
| 91 | User Phone invalid |
| 92 | User PAN invalid |
| 93 | Other user error |
| 98 | Undefined error |
| 99 | Other ITP error |

(This field may be used in conjunction
with a VERes = “N” or “U” and may
be used to indicate problems with an
ITP-based transaction.)

The “npc356authdata” field is a field that indicates the list of user authentication fields which are required. As described above, the issuer access control server computer 107 may require additional user authentication data beyond that provided in the verify enrollment request message from the authentication platform 104. The “npc356authdata” may include a list of data field that the issuer access control server computer 107 is requesting that the authentication platform 104 provide or obtain from the user. The field may contain one or more required authentication fields, and the number requested may be based on the reliability of the communications utilized for the transaction. For example, a transaction initiated via IVR may require more user authentication data than a transaction initiated via USSD.

The “name” field is a field that specifies the data being requested by the issuer access control server computer 107. Examples of data requested may include, “SP” indicating a static password, “OTP1” indicating a one-time password issued to the user prior to the transaction, “OTP2” indicating a one-time password issued to the user during the transaction, “ITP” indicating an issuer-trusted party authentication value, “ICB” indicating an issuer call-back, or other issuer-specific authentication method (e.g. “NETBANKINGPIN” indicating an internet banking pin number). The “name” field can further include additional issuer-defined fields.

In some embodiments, the “name” field is at least one character in length. In other embodiments, the “name” field is between 1 and 25 characters. In some embodiments, the “name” field is an alphanumeric field. It may also be composed of only numbers or only letters.

The “length” field is a field that specifies the maximum length of the data expected by the issuer access control server 107. In some embodiments, the “length” field is at least one character in length. In other embodiments, the “length” field is between 1 and 2 characters. In some embodiments, the “length” field is comprised of only numerals indicating the maximum number of alphanumeric characters expected in response.

The “type” field is a field that specifies the type of data expected by the issuer access control server 107. In some embodiments, the “type” field is one character in length. In other embodiments, the “type” field may contain greater than one character. In some embodiments, the “type” field is comprised of only alphanumeric characters expected in response. Example values may include, “A” indicating alphanumeric text, and “N” indicating numerals only.

The “label” field is a field that indicates the label that may be displayed on the client application. The “label” field contains a value that will be presented to the user indicating the user authentication data requested. For example, “OTP” may be contained in the “label” field to indicate that the issuer access control server computer 107 is requesting a one-time password be submitted in response to the request.

In some embodiments, the “label” field is at least one character in length. In other embodiments, the “label” field is between 1 and 20 characters. In some embodiments, the “label” field is an alphanumeric field. It may also be composed of only numbers or only letters. The “label” field may also be in universal character set transformation format—8 bit (UTF-8) which is a variable-width encoding that can represent every character in the Unicode character set.

The “prompt” field is a field that may be used by IVR clients to convert the text to voice to the user. In some embodiments, the “prompt” field may contain a sentence that can be converted from text to voice for transmission and presentation to the user portable device 102. For example, the field may contain the sentence, “Please enter OTP sent by your bank to your mobile.” The text would be converted to audio by the IVR system.

In some embodiments, the “prompt” field is at least one character in length. In other embodiments, the “prompt” field is between 1 and 80 characters. In some embodiments, the “prompt” field is an alphanumeric field. It may also be composed of only numbers or only letters, or be in UTF-8 format.

The “npc356authstatusmessage” field is a field that contains a message that may be sent to the user to provide additional information to the user during the authentication process. This field may be used to update the user as to status of the authentication process. For example, the field may contain, “OTP has been sent to your mobile,” indicating to the user that a OTP has been sent to the user portable device 102.

In some embodiments, the “npc356authstatusmessage” field is at least one character in length. In other embodiments, the “npc356authstatusmessage” field is between 1 and 40 characters. In some embodiments, the “npc356authstatusmessage” field is an alphanumeric field. It may also be composed of only numbers or only letters, or be in UTF-8 format.

The “npc356authdataencrypt” field is a field that indicates the data encryption key that is passed to the MPI/client. This key may be used to encrypt the user authentication data before passing to the issuer access control server 107 in the payer authentication request message to the issuer access control server 107. This protects the data entered by the user from other entities through which the transaction may flow. In some embodiments, this field may be used if the issuer access control server computer 107 requests a static password. In some embodiments, if dynamic data (e.g. a one-time password) is used for authentication, this field may be left blank or omitted.

The “npc356authdataencrypttype” field is a field that may indicate the type of encryption supported by the issuer access control server computer 107. For example, the field may contain “RSA” indicating that the issuer access control server computer 107 supports RSA encryption, a typical encryption algorithm. In some embodiments, this field may be used if the issuer access control server computer 107 requests a static password. In some embodiments, if dynamic data (e.g. a one-time password) is used for authentication, this field may be left blank or omitted.

In some embodiments, the “npc356authdataencrypttype” field is at least one character in length. In other embodiments, the “npc356authdataencrypttype” field is between 1 and 20 characters. In some embodiments, the “npc356authdataencrypttype” field is an alphanumeric field. It may also be composed of only numbers or only letters.

The “npc356authdataencryptkeyvalue” field is a field that indicates the actual key to be used for encrypting the user data. In some embodiments, the “npc356authdataencryptkeyvalue” field contains the encryption key that the issuer access control server computer 107 is requesting the authentication platform 104 use to encrypt the requested user authentication data. The encryption key enables the data to be encrypted and decrypted.

In some embodiments, the “npc356authdataencryptkeyvalue” field is at least one character in length. In other embodiments, the “npc356authdataencryptkeyvalue” field is between 1 and 16 characters. In some embodiments, the “npc356authdataencryptkeyvalue” field is an alphanumeric field. It may also be composed of only numbers or only letters.

The “npc356itpstatus” field is a field that indicates the status of the ITP validation (or verification process). For example, the value of the “npc356itpstatus” field may indicate a variety of errors with the ITP credentials and may indicate a problem with an ITP-based transaction. For example, a “01” may indicate that invalid credentials were submitted for the ITP, while a “92” may indicate that a user payment account number is invalid. The issuer access control server computer 107 can define additional ITP validation error codes beyond those described above.

In some embodiments, the “npc356itpstatus” field is at least one character in length. In other embodiments, the “npc356itpstatus” field is between 1 and 2 characters. In some embodiments, the “npc356itpstatus” field is an alphanumeric field. It may also be composed of only numbers or only letters.

These additional data field provide advantages. For example, more data can be delivered to the issuer access control server computer 107 so that a better authentication decision can be made.

In step 326, the issuer access control server 107 computer sends the verify enrollment response message to the authentication platform 104. The issuer access control server computer 107 may send the verify enrollment request message to the authentication platform 104 by any appropriate messaging means across an appropriate communications means, such as a network or the Internet. In some embodiments, the verify enrollment response message may be sent through the directory server computer 106. In some embodiments, the issuer access control server computer 107 sends the verify enrollment response message to the authentication platform 104 via the direct connection 126 rather than through the directory server computer 106.

In step 328, the authentication platform 104 receives and evaluates the verify enrollment response message. The authentication platform 104 may receive the verify enrollment response message from the issuer access control server computer 107 by any appropriate messaging means. The authentication platform 104 then evaluates the verify enrollment response message to determine whether the portable device 102 was verified as authentic by the issuer access control server computer 107.

If the verify enrollment response message indicates that authentication is not available, the authentication process through the issuer access control server computer 107 terminated. For example, if the issuer access control server computer 107 does not have user authentication data for the portable device 102, the authentication process through the issuer access control server computer 107 may not be able to proceed. In such scenarios, the authentication platform 104 may choose to continue the transaction as an unverified transaction or end the transaction.

In step 330, the authentication platform 104 generates a payer authentication request message. If the verify enrollment response message indicates that authentication is not available, the authentication platform 104 then generates a payer authentication request message. The payer authentication request message may be a message that is sent from the authentication platform 104 to the issuer access control server computer 107. The payer authentication request message may further comprise the additional user authentication data requested by the issuer access control server computer 107. The payer authentication request message may comply with ISO 8583, which is a standard for systems that exchange electronic transactions made by users using payment devices. The payer authentication request message according to other embodiments may comply with other suitable standards.

Exemplary data fields in the payer authentication request message are shown in the following table. These fields, fewer fields, or additional fields not described below may comprise the payer authentication request message.

| Purpose | Extension Field |
|---|---|
| Authentication User Data (The authentication user | npc356authuserdata |
| data field indicates user provided data, which is used | |
| by the issuer access control server computer 107 to | |
| authenticate the user.) | |
| Authentication User Data Name (The authentication | name |
| user data name field returns the same value sent in | |
| verify enrollment response message.) | |
| (Length - 1-25, Alphanumeric) | |
| Authentication User Data Value (The authentication | value |
| user data value field indicates the value entered by | |
| the user.) | |
| (Length - 1-80, Alphanumeric) | |
| Authentication User Encrypted Data Value (The | encrypted |
| authentication user encrypted data value field | |
| indicates if the data entered by the user was | |
| encrypted using the key provided in the verify | |
| enrollment response message. Issuer access | |
| control server computer 107 is to read this tag | |
| and decrypt the value provided by the user before | |
| processing.) | |
| TRUE | |
| FALSE | |
| (In embodiments, this attribute may always be set to | |
| “FALSE”, unless Authentication Data Name | |
| received in the verify enrollment response message | |
| is set to “SP” (Static Password)). | |
| Authentication User Data Status (The authentication | status |
| user data status field provides a status of the user | |
| interaction.) | |
| (Length - 1, Alphanumeric) | |

| | |
|---|---|
| Value | Definition |
| Y | User entered |
| N | Value not received |
| T | Transaction timed out |
| U | Undefined failure |

| | |
|---|---|
| Authentication ITP Data (The authentication ITP | npc356authitpdata |
| data field indicates data provided by the | |
| authentication platform 104 which is used by the | |
| issuer access control server computer 107 to | |
| authenticate the authentication platform 104 as an | |
| ITP.) | |
| Issuer Trusted Party (ITP) Authenticated | authenticated |
| Transaction (Indicates if the authentication platform | |
| 104 has pre-validated the cardholder prior to | |
| initiating the authentication process with the | |
| directory server computer 106 or issuer access | |
| control server computer 107.) | |
| TRUE | |
| FALSE | |
| ITP Identifier (The ITP identifier field contains a | identifier |
| value sent by the authentication platform 104 to the | |
| issuer access control server computer 107 in order to | |
| prove its relationship.) | |
| (Length - 1-80, Alphanumeric) | |

The “npc356authuserdata” field is a field that indicates user provided data, which is used by the issuer access control server computer 107 to authenticate the user.

The “name” field is a field that may returns the same value sent in the verify enrollment response message indicating the name of the user authentication data field that was request by the issuer access control server computer 107 and sent back by the authentication platform 104.

In some embodiments, the “name” field is at least one character in length. In other embodiments, the “name” field is between 1 and 25 characters. In some embodiments, the “name” field is an alphanumeric field. It may also be composed of only numbers or only letters.

The “value” field is a field that indicates the value entered by the user. For example, if the user authentication data was a one-time password, the “value” field would contain the one-time password provided by the user. In some embodiments, the “value” field is at least one character in length. In other embodiments, the “value” field is between 1 and 80 characters. In some embodiments, the “value” field is an alphanumeric field. It may also be composed of only numbers or only letters.

The “encrypted” field is a field that indicates if the data entered by the user was encrypted using the key provided in the verify enrollment response message. The issuer access control server computer 107 may read this field and decrypt the value provided by the user in the “value” field before processing. In some embodiments, the “encrypted” field may be set to either “TRUE” or “FALSE.” In some embodiments, the value in the “encrypted” field may always be set to “FALSE”, unless the “name” field received in the verify enrollment response message contains “SP” indicating a static password.

The “status” field is a field that provides a status of the user interaction. For example, the “status” field indicates the type of response received from the user regarding the requested user authentication data. For example, the value “Y” may indicate that the user entered a response to the user authentication data request, while a “T” indicates the transaction timed out and the user did not provide user authentication data.

In some embodiments, the “status” field is at least one character in length. In other embodiments, the “status” field may contain more than one character. In some embodiments, the “status” field is an alphanumeric field. It may also be composed of only numbers or only letters.

The “npc356authitpdata” field is a field that indicates data provided by the authentication platform 104 which may be used by the issuer access control server computer 107 to authenticate the authentication platform 104 as an ITP. For example, the “npc356authitpdata” field may contain a unique authentication value provided by the issuer access control server 107 to the authentication platform 104 that is used to determine the authenticity of the authentication platform 104. In some embodiments, the “npc356authitpdata” field is an alphanumeric field. It may also be composed of only numbers or only letters.

The “authenticated” field is a field that indicates if the authentication platform 104 has pre-validated the user prior to initiating the authentication process with the director server computer 106 or issuer access control server computer 107. In some embodiments, the “authenticated” field may be set to either “TRUE” or “FALSE.” For example, as an issuer-trusted party, the authentication platform 104 may have authenticated the user and/or the user portable device 104 with user authentication data stored by the authentication platform 104. In such cases, the “authenticated” field would hold the value “TRUE.”

The “identifier” field is a field that contains a value sent by the authentication platform 104 to the issuer access control server computer 107 in order to prove its relationship. The value in the “identifier” field may be the ITP credential previously contained in the verify enrollment request message and may be sent in order to further authenticated the authentication platform 104.

In some embodiments, the “identifier” field is at least one character in length. In other embodiments, the “identifier” field is between 1 and 80 characters. In some embodiments, the “identifier” field is an alphanumeric field. It may also be composed of only numbers or only letters.

In step 332, the authentication platform 104 sends the payer authentication request message to the issuer access control server computer 107 via a direct connection 126. In some embodiments, the authentication platform 104 sends the payer authentication request message to the issuer access control server computer 107 via the direct connection 126 rather than through the directory server computer 106.

In step 334, the issuer access control server computer evaluates the payer authentication request message. The issuer access control server computer 107 may evaluate the credentials presented by the authentication platform 104. For example, the issuer access control server computer 107 may validate the value in the npc356authitpdata field described above to conduct an additional validation of the authentication platform 104. This process may be necessary if the issuer access control server computer 107 wants to maintain greater control of transactions, such as to conduct a authentication check to minimize fraudulent transactions. In other embodiments, the issuer access control server computer 107 does not need to validate the authentication platform 104 as it was previously validated. If the credential validation is successful, the issuer access control server computer 107 may validate other data elements in the verify enrollment request message, including the user authentication data.

In step 336, the issuer access control server computer 107 generates a payer authentication response message based on the evaluation. Based on the evaluation of the payer authentication request message, the issuer access control server computer 107 generates an authentication response message comprised of the result of the authentication process.

In step 338, the issuer access control server computer 107 sends the payer authentication response message to the authentication platform 104. In some embodiments, the payer authentication response message may be sent through the directory server computer 106. In some embodiments, the issuer access control server computer 107 sends the payer authentication response message to the authentication platform 104 via the direct connection 126 rather than through the directory server computer 106.

In step 340, the authentication platform 104 receives and evaluates the payer authentication response message. The authentication platform 104 may parse the payer authentication response message to determine the result of the authentication conducted by the issuer access control server computer 107.

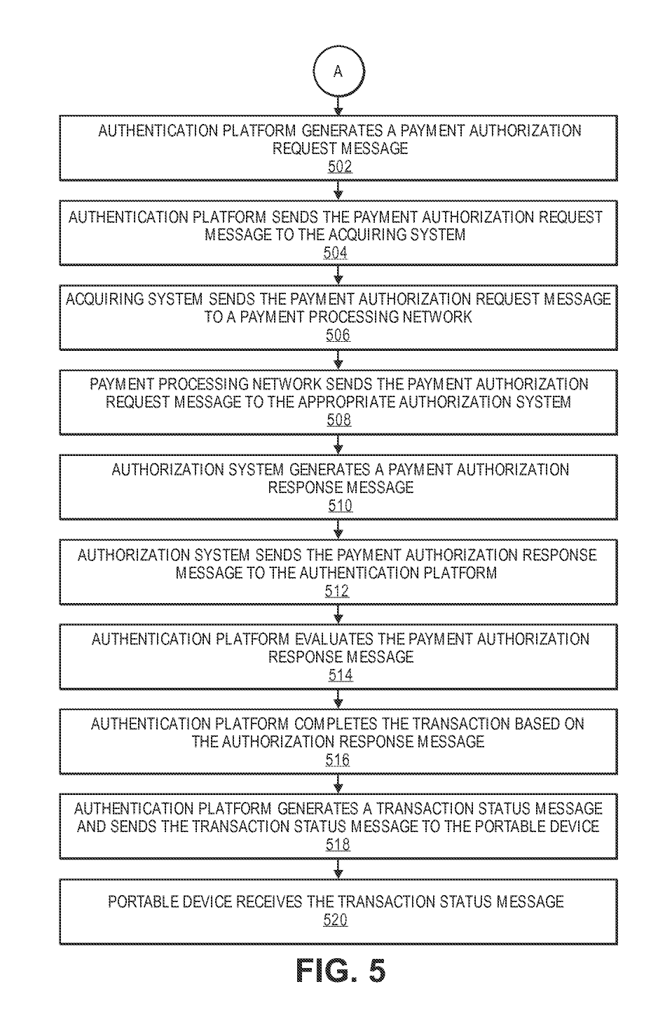

Once the authentication platform 104 determines that the transaction can proceed, based on the received payer authentication response, the authentication platform 104 continues transaction processing and can proceed with authorization, as described in FIG. 5.

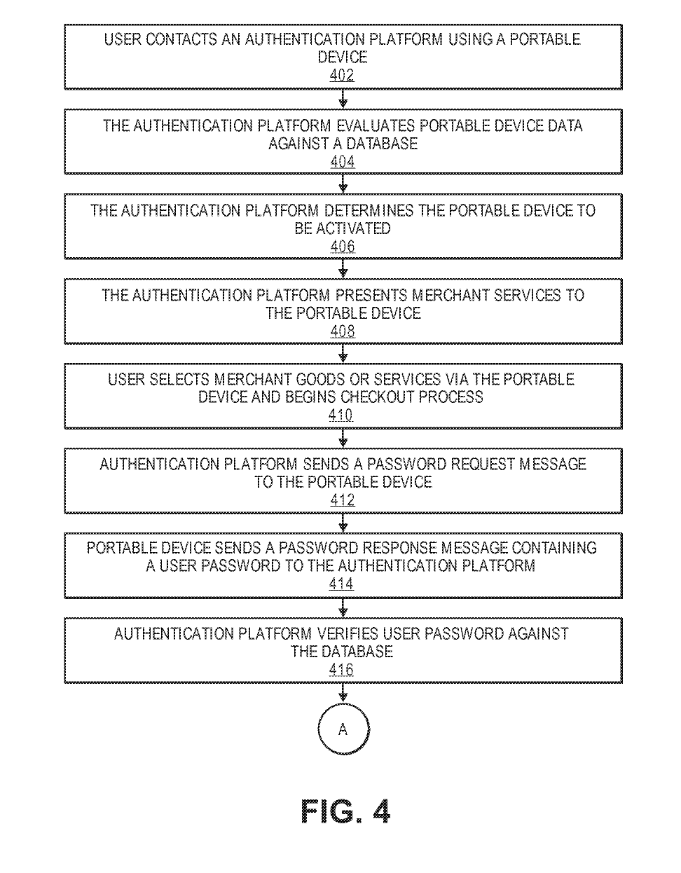

FIG. 4 is a flowchart of a method 400 illustrating an alternative process for authenticating a portable device for conducting a transaction through an authentication platform 104 using a portable device 102 using a system 100 shown in FIG. 1. In method 400, once the authentication platform 104 has authenticated the portable device 102, as the authentication platform 104 has been designated an issuer trusted party, the issuer control access server computer 107 does not require any further authentication to be conducted by the issuer control access server computer 107. In such embodiments, the verify enrollment messages and payer authentication messages, as described in FIG. 3, are not required. Thus, the transaction can proceed once the portable device 102 is authenticated by the authentication platform 104.

In step 402, the user contacts an authentication platform 104 using a portable device 102, in order to initiate an authentication process by the authentication platform 104. The user can contact the authentication platform 104 via an authentication platform SMS channel 120 or an authentication platform USSD channel 121. In some embodiments, the user dials a USSD-2 number associated with the authentication platform 104 through an authentication platform USSD channel 121. In other embodiments, the user sends an SMS message to the authentication platform 104 through an authentication platform SMS channel 120.

In step 404, the authentication platform 104 evaluates a portable device identifier against a data in a portable device database 104(B). In some embodiments, the authentication platform 104 receives a communication from the portable device 102 via the authentication platform SMS channel 120 or the authentication platform USSD channel 121. As the communication originated from the portable device 102, the authentication platform 104 can evaluate an MSISDN (or Mobile Subscriber Integrated Services Digital Network-Number) number associated with the portable device 102. The process of evaluating the portable device identifier may include checking the received MSISDN number against a portable device database 104(B) in the authentication platform 104 to determine current enrollment or registration status of the portable device 102.

In step 406, the authentication platform 104 determines the portable device 102 to be activated. After evaluating the portable device identifier against the portable device database 104(B), the authentication platform 104 determines whether the registration for the portable device 102 is activated to conduct transactions through the authentication platform 104.

In step 408, the authentication platform 104 presents merchant services to the portable device 102. Once the authentication platform 104 has determined the portable device to be activated, the authentication platform 104 can access merchant services that are available to the user. In some embodiments, the authentication platform 104 can access a list of merchant services unique to each user based on a user profile. In other embodiments, the authentication platform 104 can access a standard list of merchant services. Examples of merchant services that may be access include, but are not limited to, topping up the portable device, topping up a different portable device, sending money to another portable device, bill payments, and purchasing of goods and services.

After merchant services are accessed by the authentication platform 104, the authentication platform 104 can sends the options to the portable device 102. The merchant services can be sent to the portable device 102 using any appropriate messaging means, including SMS or USSD. In some embodiments, the merchant services can be sent to the portable device 102 through the authentication platform SMS channel 120 or the authentication platform USSD channel 121.

In step 410, the user selects merchant goods or services via the portable device 102 and begins a checkout process. As described above, a plurality of different merchant services can be presented to the user's portable device 102. The user can select the merchant services the user desires, go through the process of configuring options for the desired merchant services, and then initiate a checkout process.

In step 412, the authentication platform 104 sends a password request message to the portable device 102. The authentication platform 104 generates a password request message. The password request message may comprise a request for the user to provide the unique password that is associated with the user profile for the portable device 102 such that the user can be authenticated. In some embodiments, the password request message can be sent to the portable device 102 through the authentication platform SMS channel 120 or the authentication platform USSD channel 121.

In step 414, the portable device sends a password response message containing a user password to the authentication platform 104. The authentication platform 104 receives a password response message from the portable device 102 and stores the password response message in a database. In some embodiments, the password response message can be sent to the authentication platform 104 through the authentication platform SMS channel 120 or the authentication platform USSD channel 121.

In step 416, the authentication platform 104 verifies the user password against the database data. After receiving the password response message, the authentication platform 104 may evaluate the password response message and parse out the unique password received from the user. The authentication platform 104 may then determine if the received password matches the password associated with the portable device 102 and the user profile stored in the portable device database 104(B).

Once the authentication platform 104 determines that the transaction can proceed, based on the received payer authentication response, the authentication platform 104 continues transaction processing and can proceed with authorization, as described in FIG. 5.

FIG. 5 is a flowchart of a method 500 for initiating a payment authorization process by the authentication platform 104 for a transaction conducted through the authentication platform 104 using a portable device 102 in a system 100 shown in FIG. 1.

In step 502, the authentication platform 104 generates a payment authorization request message. The authentication platform 104 may generate the authorization request containing the transactions details provided by the user via the user's portable device 102. Transactions details may be comprised of, but are not limited to, the following: user name, user billing address, user shipping address, user portable device number, account number, items purchased, item prices, etc. The authorization request message may be generated in any suitable format. In other embodiments, a merchant computer 103 may generate the authorization request message.

In step 504, the authentication platform 104 sends the payment authorization request message to an acquiring system 108. The authorization request message is may be transmitted to the acquiring system 108. The authorization request message may be transmitted from the authentication platform 104 over an appropriate communication means, such as a network or the Internet. The authorization request message may be transmitted from the authentication platform 104 in any suitable format.

In step 506, the acquiring system 108 sends the payment authorization request message to a payment processing network 110. The authorization request message is may be transmitted from the acquiring system 108 to the payment processing network 110. The authorization request message may be transmitted from the acquiring system 108 over an appropriate communication means, such as a network or the Internet. The authorization request message may be transmitted from the acquiring system 108 in any suitable format.

In step 508, the payment processing network 110 sends the payment authorization message to the appropriate authorization system 111. After receiving the authorization request message, the payment processing network 110 may then transmit the authorization request message to the appropriate authorization system 111 associated with the portable device 102.

In step 510, the authorization system 111 generates a payment authorization response message. The authorization system 111 receives the authorization request message requesting authorization to conduct a transaction for a transaction amount using the portable device 102, where the transaction is being conducted between the portable device 102 and a merchant associated with the merchant computer 103, through the authentication platform 104. The authorization system 111 may then determine whether the transaction has been authorized or has been declined by the authorization system 111. In some embodiments, the authorization system 111 evaluates the account associated with the portable device 102 to determine whether the account has sufficient funds for the transaction amount. In some embodiments, the authorization system 111 may evaluate the contents of the authorization request message to determine whether the transaction satisfies pre-established conditions and settings established by the user.

In step 512, the authorization system 111 sends the payment authorization response message to the authentication platform 104. The authorization system 111 can send the authorization response message back to the authentication platform 104 through the payment processing network 110 and the acquiring system 108. The message may be sent by an appropriate messaging means.

In step 514, the authentication platform 104 evaluates the payment authorization response message. The authentication platform 104 may parse the received authorization response message to determine whether the authorization system 111 approved or declined the transaction.

In step 516, the authentication platform 104 completes the transaction based on the authorization response message. If the transaction was approved by the authorization system 111, the authentication platform 104 may complete the transaction by storing the transaction data in a reconciliation file for future clearing and settlement processes. If the transaction was declined or rejected by the authorization system 111, the authentication platform 104 may end the transaction without further processing.

In step 518, the authentication platform 104 generates a transaction status message sends the transaction status message to the portable device 102. If the transaction was approved by the authorization system 111, the authentication platform 104 may generate and send a message to the portable device 102 informing the user that the transaction was approved. The message may further indicate the finalized details of the transaction. If the transaction was declined or rejected by the authorization system 111, the authentication platform 104 may generate and send a message to the portable device 102 informing the user that the transaction was declined.

In step 520, the portable device 102 receives the transaction status message. After the authentication platform 104 generates transaction status message, the transaction status message is transmitted to the portable device 102. The transaction status message may be sent in any appropriate messaging format. In some embodiments, the transaction status message can be sent to the portable device 102 through the authentication platform SMS channel 120 or the authentication platform USSD channel 121.

FIG. 6 is a flowchart of a method 600 of clearing and settling a financial transaction involving a portable device 102 of a user through an authentication platform 104 using a system 100 shown in FIG. 1.

A clearing and settlement process may include a process of reconciling a transaction. A clearing process is a process of exchanging financial details between an acquiring system 108 and an authorization system 111 to facilitate posting to an account and reconciliation of the user's settlement position. Settlement involves the delivery of securities from one user to another. In some embodiments, clearing and settlement can occur simultaneously.

In step 605, the authentication platform 104 generates and sends a settlement file including transaction details for the merchant computer 103, to the acquiring system 108. The settlement file contains the transaction details for transactions conducted between the portable device 102 and the merchant computer through the authentication platform 104. The settlement file is used in a clearing and settlement process. The transaction may have been conducted through the authentication platform 104 as described above with respect to FIGS. 3-5. The authentication platform 104 will send a settlement file to an acquiring system 108 containing transactions. The settlement file may be submitted periodically throughout the day, or more commonly, at the end of the day.

In step 610, the acquiring system 108 sends the settlement file containing the transaction details, to the payment processing network 110. The acquiring system 108 associated with a merchant computer 103 receives the settlement file containing the transactions conducted using the portable device 102 through the authentication platform 104, and routes them to the payment processing network 110.

In step 615, the payment processing network 110 parses the settlement file. The payment processing network settles the transaction against the outstanding transactions conducted using the portable device 102 through the authentication platform 104.

In step 620, the payment processing network 110 sends the settlement file to the appropriate authorization system 111 for the transaction amount. In some embodiments of the claimed invention, the payment processing network 110 determines the appropriate authorization system 111 to send the settlement file to, based on the contents of the settlement file. For example, the payment processing network 110 may parse out the account information for an account associated with the portable device 102. The payment processing network 110 can then route the settlement file to the authorization system 111 for the account associated with the portable device 102.

In step 625, the authorization system 111 transmits the funds to the acquiring system 108. After receiving the settlement file at the authorization system 111, the authorization system 111 charges the transaction amount against the account associated with the portable device 102. The hold placed against the credit limit of the account associated with the portable device 102 is then debited by the transaction amount. Once the transaction amount is charged against the account associated with the portable device 102, the authorization system 111 transmits the funds back to the acquiring system 108 via the payment processing network 110.

In step 630, the acquiring system 108 provides funds to an account associated with the merchant computer 103. Once the acquiring system 108 receives the funds from the authorization system 111, the acquiring system 108 credits an account associated with the merchant computer with the transaction amount.

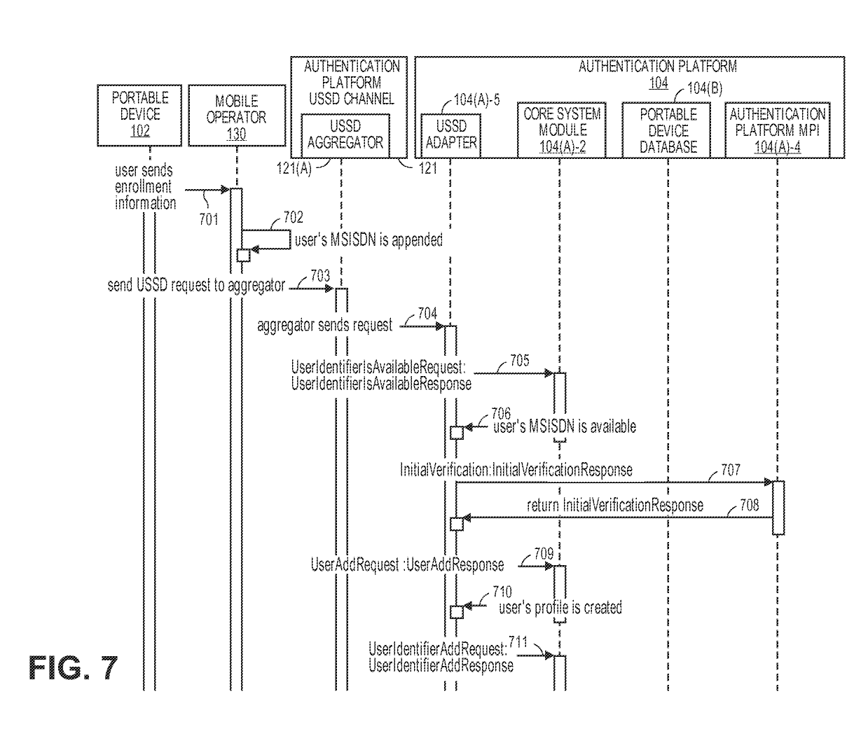

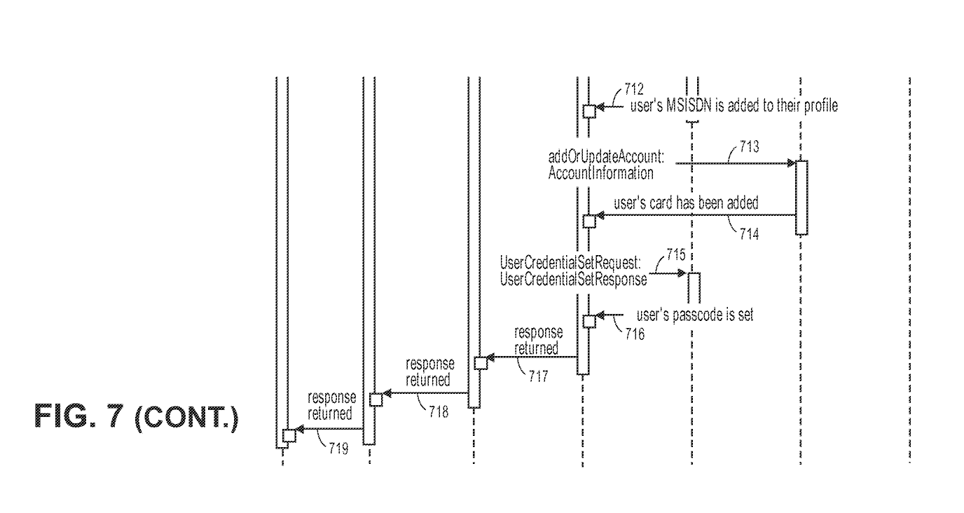

FIG. 7 illustrates a sequence diagram describing the process of registering a portable device for enrollment through a system according to an embodiment of the invention. Although several components are depicted in FIG. 7, there may be additional components not depicted that may interact with the depicted components.

In step 701, the user sends enrollment information from the user's portable device 102 to a mobile operator 130 of the portable device 102. The mobile operator 130 may provide network, voice, and data services to mobile phone subscribers. The mobile operator 130 is responsible for sending communications from the portable device 102 to the authentication platform 104. The user may send enrollment information by opening a USSD session on their portable device 102 and communicate with the application platform 104 through an authentication platform USSD channel 121. In other embodiments, the enrollment information may be sent through SMS messaging through an authentication platform SMS channel 120.

In step 702, the mobile operator 130 appends the MSISDN of the portable device 102 to the enrollment information. The MSISDN is appended as a portable device identifier that can uniquely identify the portable device 102.

In step 703, the mobile operator 130 sends a USSD request to the USSD aggregator 121(A). The USSD aggregator 121(A) receives USSD requests from a plurality of mobile operators 130 and aggregates the USSD requests for the authentication platform 104.

In step 704, the USSD aggregator 121(A) sends the USSD request to the USSD adapter 104(A)-5. In some embodiments, the USSD aggregator 121(A) sends the USSD request to the USSD adapter 104(A)-5 in order to translate the message contained in the USSD request into a standard message format utilized by the authentication platform 104.

In step 705, the USSD adapter 104(A)-5 sends a User Identifier Is Available request message to the core system module 104(A)-2 in the authentication platform 104. The User Identifier Is Available request message is a request message to determine whether a user identifier (or portable device identifier), such as a MSISDN associated with the portable device 102, is contained in the enrollment information received from the portable device 102. In some embodiments, the core system module 104(A)-2 and the USSD adapter 104(A)-5 may be a single module that is capable of conducting the operations of the two separate modules.

In step 706, the core system module 104(A)-2 sends a User Identifier is Available response message indicating that the user's MSISDN is available to the USSD adapter 104(A)-5.

In step 707, the USSD adapter 104(A)-5 sends an initial verification message to the authentication platform MPI 104(A)-4. In embodiments, the initial verification message may be sent to an issuer access control server computer 107 via a directory server computer 106 or via a direct connection 126 in order for the user enrollment data, including the user authentication data. The issuer access control server computer 107 determines whether the data in the initial verification message is authentic and generates an initial verification response message. The initial verification response message is transmitted back to the authentication platform MPI 104(A)-4, either through the directory server computer 106 or via the direct connection 126.

In step 708, the authentication platform MPI 104(A)-4 sends the initial verification response message to the USSD adapter 104(A)-5. In some embodiments, the initial verification response message may be sent to the core system module 104(A)-2 prior to being sent to the USSD adapter 104(A)-5.

In step 709, the USSD adaptor 104(A)-5 generates a User Add request message requesting that a user profile be created and sends the User Add request message to the core system module 104(A)-2. The User Add request message may request the authentication platform 104 create a user profile for the user associated with the portable device 102.

In step 710, the core system module 104(A)-2 generates a User Add Response Message stating that the user profile has been created and sends the User Add Response Message to the USSD adaptor 104(A)-5. The User Add Response Message may indicate that the user profile has been created in the authentication platform 104.

In step 711, the USSD adaptor 104(A)-5 generates a User Identifier Add request message and sends the User Identifier Add request message to the core system module 104(A)-2 in the authentication platform 104. The User Identifier Add request message is a message requesting that the MSISDN for the user's portable device 102 be added to the user profile in the authentication platform 104.

In step 712, the core system module 104(A)-2 generates a User Identifier Add response message and sends the User Identifier Add response message to the USSD adaptor 104(A)-5. The User Identifier Add response message is a message indicating that the MSISDN for the user's portable device 102 has been added to the user profile in the authentication platform 104.

In step 713, the USSD adaptor 104(A)-5 generates an Add or Update Account message and sends the Add or Update Account message to the portable device database 125(B) in the authentication platform 104. The Add or Update Account message may be comprised of at least a user identifier, a user account number, user address, and other user identification and user account data. In some embodiments, when the user profile has been previously established, the Add or Update Account message can be used to update any data contained in the user profile.

In step 714, the portable device database 125(B) generates an Add or Update Account response message and sends the Add or Update Account response message to the USSD adaptor 104(A)-5. The Add or Update Account response message may indicate that that the account information in the user profile has either been updated (if pre-existing) or added to the authentication platform 104.

In step 715, the USSD adaptor 104(A)-5 generates a User Credential Set request message requesting that the user's credentials including a user passcode or user password be established.

In step 716, the core system module 104(A)-2 generates a User Credential Set response message stating that the user's passcode or use password has been established and sends the password set message to the USSD adaptor 104(A)-5. In some embodiments, the process of requesting and storing the user password or passcode may be conducted prior to sending the initial verification message.

In step 717, the USSD adaptor 104(A)-5 sends the User Credential Set response message to the USSD aggregator 121(A).

In step 718, the USSD aggregator 121(A) sends the User Credential Set response message to the mobile operator 130.

In step 719, the mobile operator 130 sends the User Credential Set response message back to the user via the user's portable device 102. The message may be displayed on the screen of the portable device 102 to indicate that the user's enrollment has been successfully completed and the user is now authenticated to conduct transactions through the authentication platform 104.

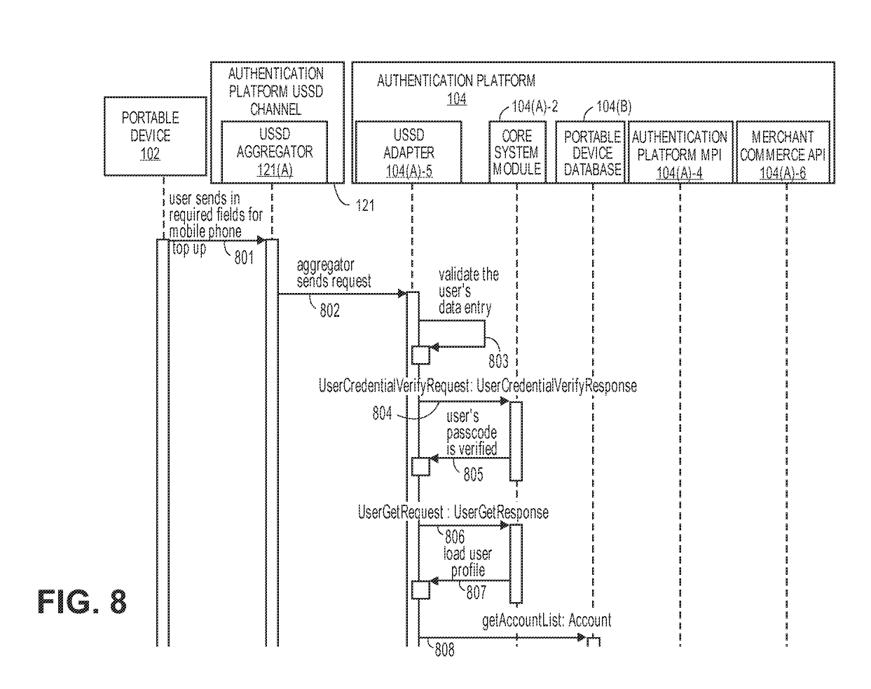

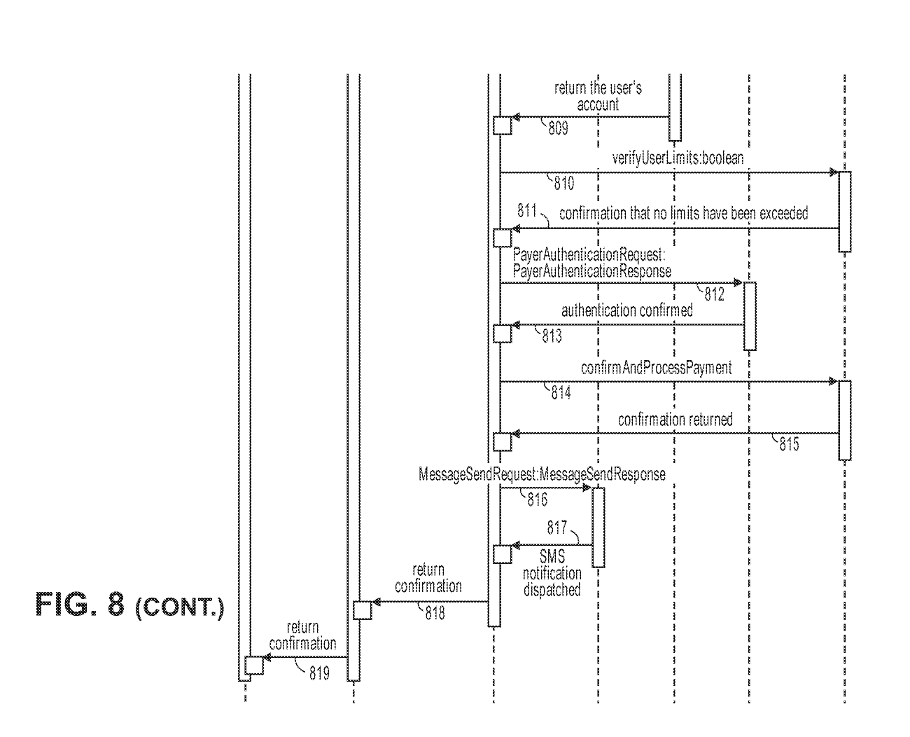

FIG. 8 illustrates a sequence diagram describing the process of topping up a portable device through a system according to an embodiment of the invention. Topping up is a service that allows a user to add funds to or replenish an account. For example, a user may top up an account associated with their portable device 102 by accessing the authentication platform 104. Although several components are depicted in FIG. 8, there may be additional components not depicted that may interact with the depicted components.

In step 801, the user sends in the required fields for topping up a portable device from the user's portable device 102. The data may be sent from the portable device 102 to a USSD aggregator 121(A) in a topping up request message. In some embodiments, the required fields are sent in a message through a mobile operator. The user may send the required fields for topping up a portable device by opening a USSD session on the user's portable device 102 and communicate with the application platform 104 through an authentication platform USSD channel 121. In other embodiments, the required fields for topping up a portable device may be sent through SMS messaging through an authentication platform SMS channel 120. The topping up request message may be comprised of data including the mobile phone number to top up, the amount of the top up, and the user password. Examples of the data sent as part of the topping up request is depicted in FIGS. 10B-10E.

In step 802, the USSD aggregator 121(A) sends the topping up request message to the USSD adapter 104(A)-5. In some embodiments, the USSD aggregator 121(A) sends the topping up request message to the USSD adapter 104(A)-5 in order to translate the topping up request message into a standard message format utilized by the authentication platform 104.

In step 803, the USSD adapter 104(A)-5 may validate the topping up request message prior to conducting further processing. The validation may include ensuring the data is in the correct message format and that all the required data is contained in the topping up request message.

In step 804, the USSD adapter 104(A)-5 sends a user credential verification request message to the core system module 104(A)-2 in the authentication platform 104. The user credentials verification request message may include the user passcode (or password) provided by the user in order to authenticate the user and the portable device 102 and an MSISDN received from the portable device 102.

In step 805, the core system module 104(A)-2 send a user credential verification response message to the USSD adapter 104(A)-5 indicating whether the user password has been verified by the authentication platform 104. Once the user credentials have been verified, the authentication platform 104 can continue transaction processing.

In step 806, the USSD adapter 104(A)-5 sends a user get request message to the core system module 104(A)-2. The user get request message may include a request for a user profile associated with the user and the portable device 102 to be accessed and loaded. In some embodiments, the user profile is accessed based on the credentials provided by the user, including the MSISDN and the user password.

In step 807, the core system module 104(A)-2 sends a user get response message to the USSD adapter 104(A)-5. The user get response message may be generated based on the result of accessing and loading the user profile. If the operation was successful, the core system module 104(A)-2 may indicate that the user profile has been loaded. The user get response message may also comprise of a list of accounts accessible to the user.

In step 808, the USSD adapter 104(A)-5 sends a get account list request message to the portable device database 125(B). The get account list request message may be comprised of a user identifier or a user account number. In embodiments, where the user has a plurality of accounts, the get account list request message may comprise a selection, by the user, of one of the plurality of accounts.

In step 809, the portable device database 125(B) sends a get account list response message to the USSD adapter 104(A)-5. The get account list response message may be generated based on the result of accessing and loading the user account associated with the received user identifier and/or user account number. If the operation was successful, the core system module 104(A)-2 may return the user's account in the get account list response message.

In step 810, the USSD adapter 104(A)-5 sends a verify user limits request message to the merchant commerce API 104(A)-6 to verify the user account limits. In some embodiments, the verify user limits request message is sent to the authorization system 111 associated with the user's account to determine whether a limit has been reached. The authorization system 111 may be messaged by the merchant commerce API 104(A)-6 through the acquiring system 108 and payment processing network 110. The authorization system 111 may generate and send a verify user limits response message that is sent back through the payment processing network 110 to the acquiring system 108 to the merchant commerce API 104(A)-6.

In step 811, the merchant commerce API 104(A)-6 returns the verify user limits response message indicating whether any account limits have been exceeded. Assuming the no limits have been exceeded, the topping up transaction can continue.

In step 812, a payer authentication request message is sent from the USSD adapter 104(A)-5 to the authentication platform MPI 104(A)-4. The authentication platform MPI 104(A)-4 can communicate with an issuer access control server computer 107 as part of a process of authenticating the user and the portable device 102. The payer authentication request message may include, among other data, user authentication data that may be used to authenticate the user. Examples of payer authentication data include account number, user password, user date of birth, last four digits of social security number, and the like.

In embodiments, the payer authentication request message may be sent to an issuer access control server computer 107 via a directory server computer 106 or via a direct connection 126 in order for the user enrollment data, including the user authentication data. The issuer access control server computer 107 determines whether the data in the payer authentication request message is authentic and generates a payer authentication response message. The payer authentication response message is transmitted back to the authentication platform MPI 104(A)-4, either through the directory server computer 106 or via the direct connection 126.

In step 813, once the authentication process has been completed, the authentication platform MPI 104(A)-4 sends back a payer authentication response message to the USSD adapter 104(A)-5. The payer authentication response message indicates whether the authentication has been verified or declined.

In step 814, the USSD adapter 104(A)-5 sends a request to the merchant commerce API 104(A)-6 to confirm and process the payment for the topping up transaction. In some embodiments, this process may include sending an authorization request message that is sent through an acquiring system 108 and a payment processing network 110 to an authorization system 111. Once the transaction has been authorized by the authorization system 111, the authorization system 111 generates and sends an authorization response message indicting whether the transaction was approved or declined.

In embodiments, the authorization response message may also be sent to the merchant computer 103 to notify the merchant computer 103 that a topping up transaction has been successfully completed and that the account associated with the topping up transaction should be topped up. For example, the authorization response message may indicate that the user successfully completed a payment authorization for $20 to be topped up to the user's account. The merchant computer 103 may then add $20 the user's account. For example, data that may be included in the authorization response message sent to the merchant computer 103 is depicted in FIG. 10E.

In step 815, the merchant commerce API 104(A)-6 returns a message to the USSD adapter 104(A)-5 indicating that topping up transaction has been processed. In some embodiments, this process may include sending an authorization response message that is sent from an authorization system 111 back to the merchant commerce API 104(A)-6.

In step 816, the USSD adapter 104(A)-5 sends a message send request message to the core system module 104(A)-2. In some embodiments, the message send request message may be a request for the authentication platform 104 to send a confirmation message to the user portable device 102 confirming that the topping up transaction has been successfully completed.

In step 817, the core system module 104(A)-2 generates and sends an SMS notification message to the USSD adapter 104(A)-5. The SMS notification may be a confirmation message indicating that the topping up transaction was successfully completed. An example of a typical SMS notification message indicating that the topping up transaction was successfully completed in depicted in FIG. 10G.

In step 818, the USSD adapter 104(A)-5 forwards the SMS notification message to the USSD aggregator 121(A). In some embodiments, the USSD Adapter 104(A)-5 may also translate the SMS notification message into another messaging format, other than SMS messaging, suitable for the portable device 102.

In step 819, the USSD aggregator 121(A) sends the SMS notification message back to the user via the user's portable device 102. The SMS notification message may be displayed on the screen of the portable device 102 to indicate that the topping up transaction was successfully completed.

With respect to FIG. 8, a similar process can be carried out for other merchant services, such as bill payments, purchasing goods/services (e.g. movie tickets), and to transfer funds between two accounts.

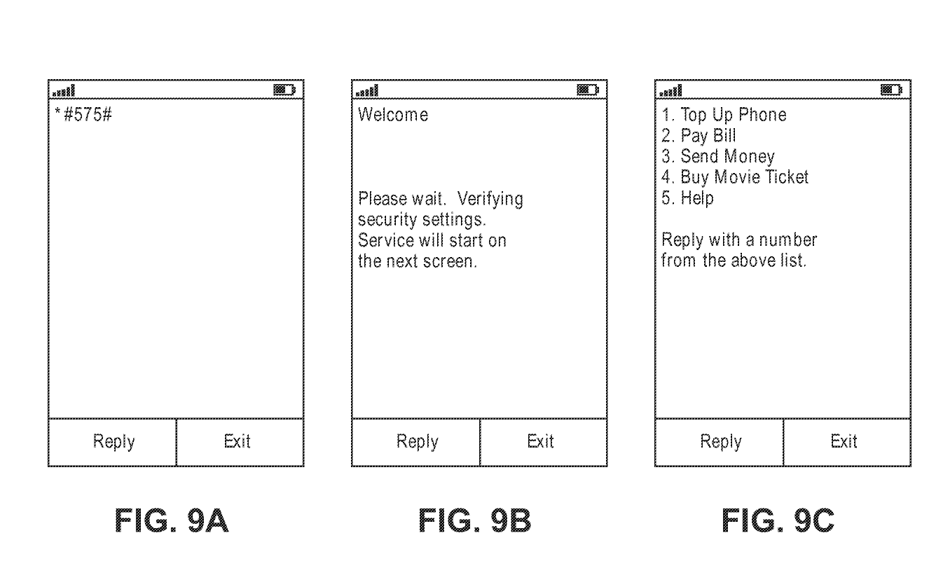

FIGS. 9A-9C show a depiction of an interface with an authentication platform 104 using a portable device according to an embodiment of the invention. The depiction in FIGS. 9A-9C is one embodiment using a non-touch-screen portable device 102. Other embodiments contemplate the use of touch-screen portable devices 102.

In FIG. 9A, the user accesses the authentication platform 104 by dialing a number associate with the authentication platform 104. In this example, the user dials a USSD-2 number (e.g. *#575#) on the portable device 102. In other embodiments, the user may access the authentication platform 104 through other communications means, such as through SMS messaging or through a dedicated mobile application installed on the user's portable device 102. User inputs through the portable device 102 may be in the form of a string of characters and can be inputted via a physical keyboard or a virtual keyboard.

In FIG. 9B, once the user has accessed the authentication platform 104 via the portable device 102, the authentication platform 104 may conduct an authentication process in order to verify the portable device 102. In some embodiments, the authentication platform 104 may evaluate an MSISDN number received from the portable device 102 to determine whether the portable device 102 is activated to conduct transactions through the authentication platform 104.

In FIG. 9C, following successful verification of the portable device 102, the authentication platform 104 presents the user with a plurality of merchant services. For example, the authentication platform 104 may provide the portable device 102 with the following merchant services: top up phone, pay bill, send money, and buy movie ticket. The authentication platform 104 may also provide a Help option. Other embodiments may include these merchant services, fewer merchant services, or additional merchant services than those depicted in FIG. 10C. In some embodiments, the plurality of merchant services presented by the authentication platform 104 may be unique to the user based upon a user profile. In other embodiments, the plurality of merchant services may be uniform for all users who access the authentication platform 104.

FIGS. 10A-10G show a depiction of the process of topping up a portable device 102 through an interface with an authentication platform 104, using the portable device 102, according to an embodiment of the invention. In other embodiments, the user may access the authentication platform 104 through other communications means, such as through SMS messaging or through a dedicated mobile application installed on the user's portable device 102.

In FIG. 10A, the portable device 102 displays a plurality of merchant services accessible through the authentication platform 104.

In FIG. 10B, the user has selected option “1” to top up a mobile phone 102. The user is given the option of topping up their own mobile phone (e.g. the portable device 102 accessing the authentication platform 104) or a different mobile phone.

In FIG. 10C, after selecting the option to top up a different mobile phone, the user submits a mobile phone number to top up through the authentication platform 104, using the portable device 102, and then selects an amount to top up the mobile phone with. In other embodiments, the user can select an amount to top up in one or more currencies.

In FIG. 10D, the authentication platform 104 prompts the user to reply to the authentication platform 104 with a unique user PIN or password associated with the portable device 102. In some embodiments, the unique user PIN or password was created by the user during an enrollment process conducted through the authentication platform 104, as described with respect to FIG. 2.

In FIG. 10E, the authentication platform 104 presents the user with a transaction confirmation page to allow the user either to confirm the transaction or to cancel the transaction. The transaction confirmation page may include the mobile number to be topped up and the top up amount.

In FIG. 10F, after the user has selected to confirm the topping-up transaction through the portable device 102, the authentication platform 104 presents a message to the portable device 102 that the top-up request is being processed and notifies that user that they will receive a confirmation regarding the transaction.

In FIG. 10G, a confirmation message indicating successful completion of the topping-up transaction through the authentication platform 104 is depicted. In some embodiments, the confirmation message may be sent in an SMS message, or by any other appropriate messaging means, including electronic mail, telephone call, or by physical mail.

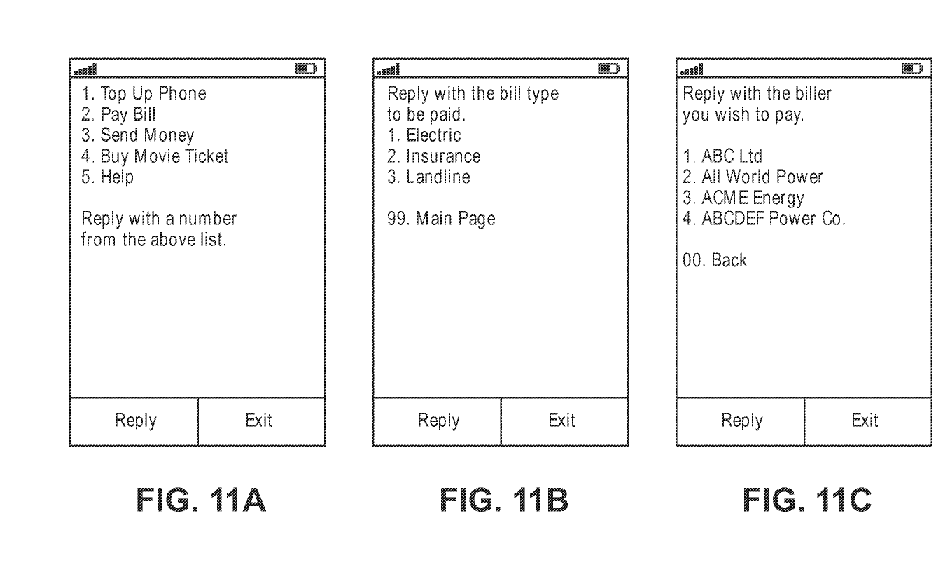

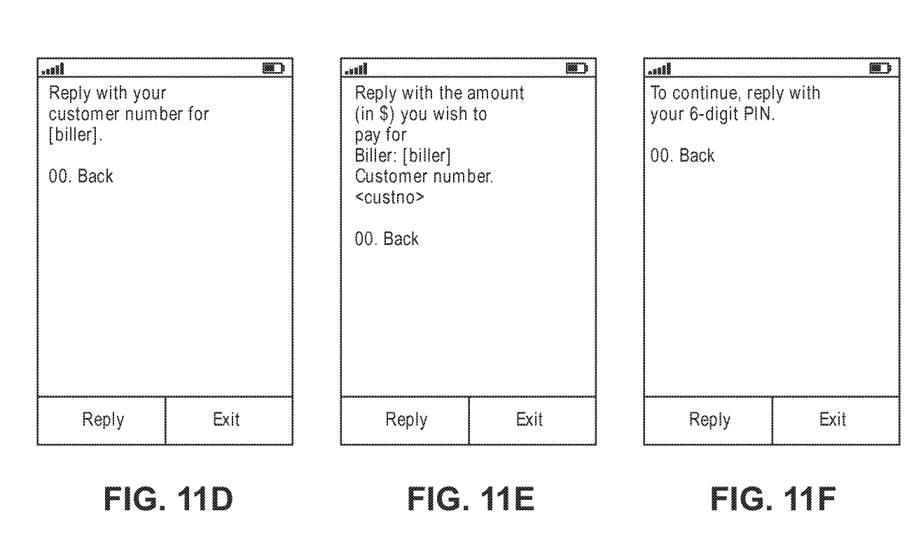

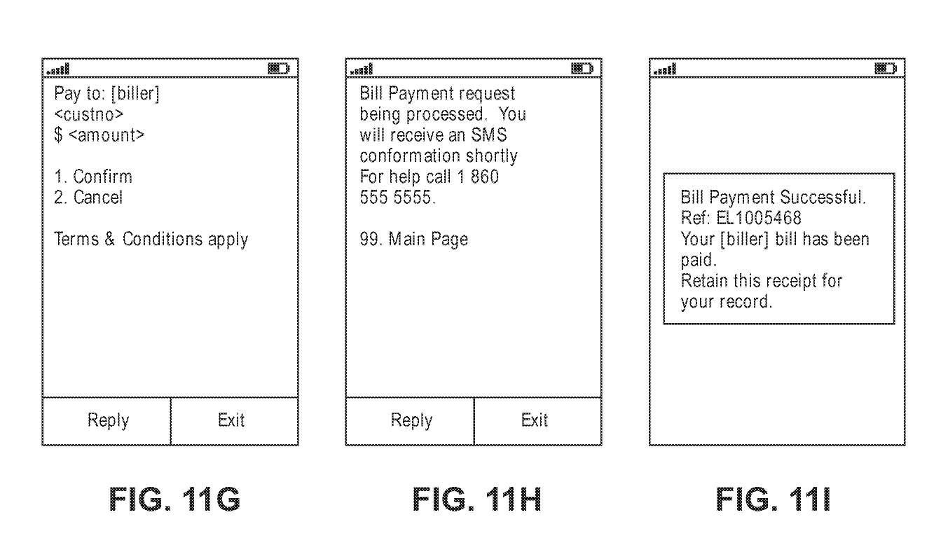

FIGS. 11A-11I show a depiction of the process of conducting a bill payment through an interface with an authentication platform 104, using a portable device 102, according to an embodiment of the invention. In other embodiments, the user may access the authentication platform 104 through other communications means, such as through SMS messaging or through a dedicated mobile application installed on the user's portable device 102.

In FIG. 11A, the portable device 102 displays a plurality of merchant services accessible through the authentication platform 104.

In FIG. 11B, the user has selected option “2” to pay a bill through the authentication platform 104. The user is given the option of paying an electric bill, an insurance bill, or a landline telephone bill. Embodiments are not limited to the payment of utility bills, and may include credit card bills, loan payments, car payments, and the like.

In FIG. 11C, after selecting the option to submit a bill payment through the authentication platform 104 for an electric bill, the user is presented with one or more billers that can be paid. In some embodiments, the authentication platform 104 presents all companies that are able to accept bill payments through the authentication platform 104. In other embodiments, the authentication platform 104 presents only those companies with which the user has an established account, based on a profile established by the user.

In FIG. 11D, after the user selects a company to send the bill payment to, the user is prompted by the authentication platform 104 to submit their customer number for the selected company. In some embodiments, based on the profile established by the user, the authentication platform 104 has the customer number stored in the portable device database 104(B) such that once the user selects the company to send the bill payment to, the authentication platform 104 automatically populates the required fields with the user's account information.

In FIG. 11E, the authentication platform 104 prompts the user to enter an amount to send in the bill payment. In other embodiments, the user can select from one or more currencies in which to submit the bill payment.

In FIG. 11F, the authentication platform 104 prompts the user to reply to the authentication platform 104 with a unique user PIN or password associated with the portable device 102. In some embodiments, the unique user PIN or password was created by the user during an enrollment process conducted through the authentication platform 104, as described with respect to FIG. 2.

In FIG. 11G, the authentication platform 104 presents the user with a transaction confirmation page to allow the user either to confirm the transaction or to cancel the transaction. The transaction confirmation page may include bill payment recipient, the customer number, and the amount of the bill payment.

In FIG. 11H, after the user has selected to confirm the bill payment transaction through the portable device 102, the authentication platform 104 presents a message to the portable device 102 that the bill payment request is being processed and notifies that user that they will receive a confirmation regarding the transaction.

In FIG. 11I, a confirmation message indicating successful completion of the bill payment transaction through the authentication platform 104 is depicted.

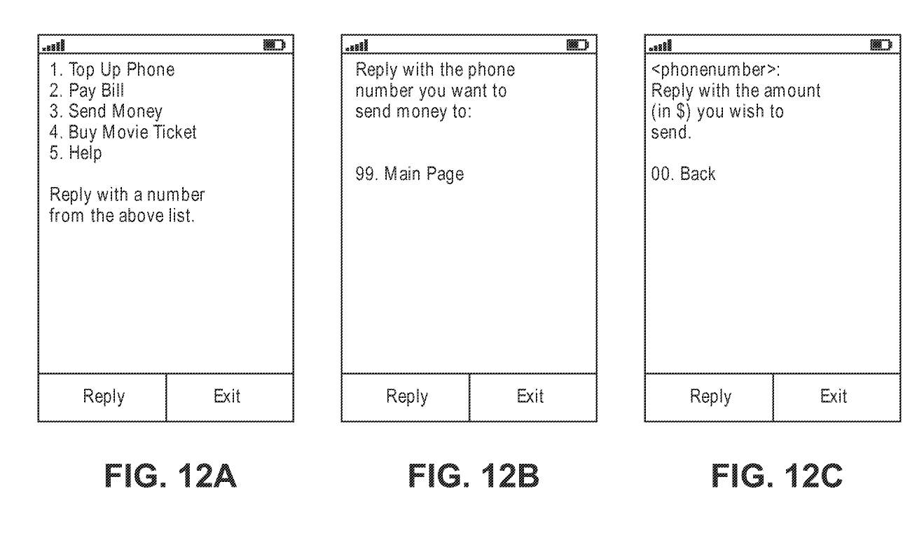

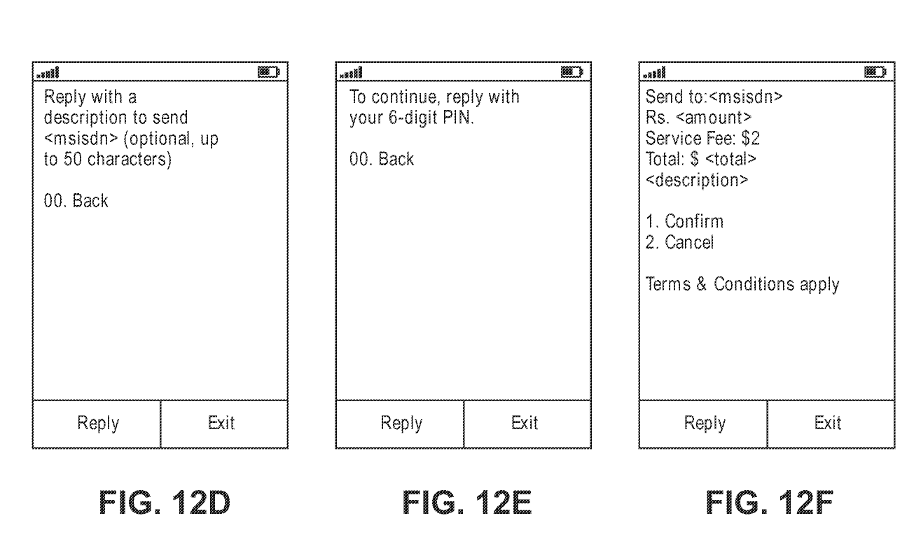

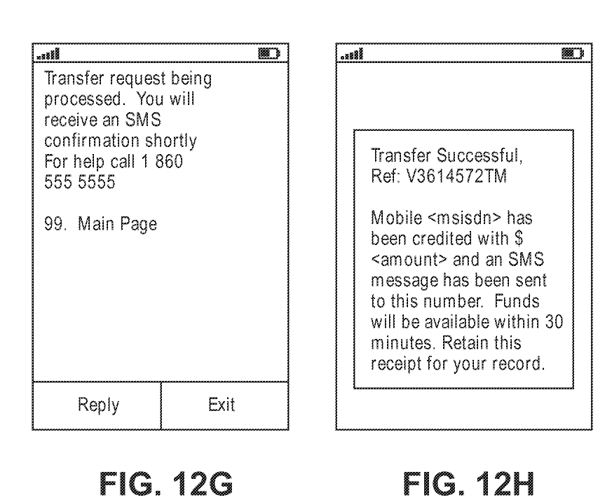

FIGS. 12A-12H show a depiction of the process of sending monetary funds between portable devices through an interface with an authentication platform 104, using a portable device 102, according to an embodiment of the invention. In other embodiments, the user may access the authentication platform 104 through other communications means, such as through SMS messaging or through a dedicated mobile application installed on the user's portable device 102.

In FIG. 12A, the portable device 102 displays a plurality of merchant services accessible through the authentication platform 104.

In FIG. 12B, the user has selected option “3” to transfer money through the authentication platform 104 to a receiving mobile phone. The user is prompted to provide the mobile phone number of the receiving mobile phone to transfer the money. In some embodiments, the user is prompted to provide a phone number associated with a mobile phone (e.g. portable device 102) that is also enrolled and activated for use with the authentication platform 104.

In FIG. 12C, the authentication platform 104 prompts the user to enter an amount to transfer to the receiving mobile phone. In other embodiments, the user can select from one or more currencies in which to submit the transfer money request.

In FIG. 12D, the authentication platform 104 prompts the user to reply with a description to send to the receiving mobile phone. In some embodiments, the description is an optional step in the transfer money process that is sent to the receiving mobile phone notifying the receiving mobile phone the purpose of the transferred money.

In FIG. 12E, the authentication platform 104 prompts the user to reply to the authentication platform 104 with a unique user PIN or password associated with the portable device 102. In some embodiments, the unique user PIN or password was created by the user during an enrollment process conducted through the authentication platform 104, as described with respect to FIG. 2.

In FIG. 12F, the authentication platform 104 presents the user with a transaction confirmation page to allow the user either to confirm the transaction or to cancel the money transfer process. The transaction confirmation page may include, but is not limited to, the receiving mobile phone number, the amount of the money transfer, the amount of a service fee, the total charge of the money transfer, and the description provided by the user.

In FIG. 12G, after the user has selected to confirm the money transfer transaction through the portable device 102, the authentication platform 104 presents a message to the portable device 102 that the money transfer request is being processed and notifies that user that they will receive a confirmation regarding the transaction.

In FIG. 12H, a confirmation message indicating successful completion of the money transfer transaction through the authentication platform 104 is depicted.

### III. TECHNICAL BENEFITS

A benefit of embodiments of the invention is the ability to conduct a user authentication process and a portable device authentication process at an authentication platform that is an issuer trusted party. In some embodiments, once the user and the portable device have been authenticated by the authentication platform, the transaction can proceed to the payment authorization process. As the authentication platform is considered an issuer trusted party and has stored authentication data for the user and the portable device, the authentication platform can be made solely responsible for authenticating the user and portable device. Thus, the authentication process does not require the generation and transmission of additional authentication messages between the authentication platform and an issuer access control server computer. This provides the benefit of making transactions more efficient and less time-consuming.

The use of enhanced messaging during the authentication process between the issuer trusted party and the issuer access control server also provides additional benefits. New data fields provide the issuer systems with additional information that can be utilized to streamline the authentication process. For example, by including indicators, such as how the transaction was initiated and type of communication channel accessible by a portable device, allows the issuer system and issuer trusted party to communicate efficiently.

An additional benefit of embodiments of the invention is the ability to use existing infrastructure (e.g. mobile network and standard mobile phones) by allowing users and merchants to complete transaction processing via SMS messaging or through USSD. This allows for any individual with a standard mobile phone to be able to access an authentication platform in order to access merchant services and complete transactions with merchant. By using the authentication platform, transactions can be completed without the need for payment cards or equipment to process payment cards.

An additional benefits of embodiments of the invention is a reduction in the number of fraudulent transactions being authorized and processed. In scenarios where both the authentication platform, that is an issuer trusted party, and the issuer access control server computer conduct user authentication and portable device authentication, the dual authentication processes may assist in minimizing the possibility of a fraudulent transaction being authorized and processed. For example, there may be a scenario where the authentication platform has outdated and compromised authentication data, while the issuer access control server has more recent and secure authentication data. In such a scenario, a potentially fraudulent transaction may be authenticated by the authentication platform, but declined by the issuer access control server computer.

### IV. ADDITIONAL EMBODIMENTS

An additional embodiment of the invention may further involve the issuer access control server computer establishing criteria for determining the appropriate authentication process for a transaction. Additional criteria that may be used by the issuer access control server computer may include, but is not limited to, merchant category, merchant location, items in transaction, and time of transaction. For example, the issuer access control server computer may allow minor transactions (e.g. transactions under $20) to be solely authenticated by the authentication platform, but require that any more significant transactions (e.g. transactions greater than $20) be sent to the issuer access control server computer for additional user and/or portable device authentication. In another example, the issuer access control server computer may require that all transactions occurring between midnight and 6 A.M. local time to the user be sent to the issuer access control server computer for additional user and/or portable device authentication.

An additional embodiment of the invention is directed to mitigating the risk of mobile number spoofing. Mobile number spoofing is the practice of masking the actual mobile number being used to conduct a communications by replacing it with a fraudulent mobile number, in order to make it appear as though the communications is being conducted by the fraudulent mobile number. This issue is of particular concern for Interactive Voice Response (IVR) communications with the authentication platform as call forwarding can be easily used to disguise the actual mobile number.

In an embodiment using USSD, when the user initiates a USSD session with the authentication platform, the authentication platform may immediately terminate the session and send a new USSD session to the user's portable device. In this scenario, the threat of mobile number spoofing may be reduced, as the authentication platform will attempt to call back the mobile number presented to the authentication platform in the initial USSD session. If the mobile number presented to the authentication platform is legitimate, the portable device can then be registered.

In another embodiment designed to minimize the risk of mobile number spoofing, in order to conduct a registration process with the authentication platform, the user may be required to enter a one-time password that was provided by the authentication platform to the portable device, via a messaging means, such as SMS messaging. The registration process can proceed as in the main embodiment. Once authenticated by the issuer access control server computer, the user can establish a user password with the authentication platform that would be used for future transactions through the authentication platform. In this embodiment, the threat of mobile number spoofing is also reduced mitigated as the authentication platform will be able ensure that the portable device that is being used to register with the authentication platform intended to be registered.

Other embodiments of the invention include a method comprising: providing, by a portable device operated by a user, a transaction initiation request to an authentication platform, wherein the authentication platform was previously verified as an issuer trusted party, wherein the authentication platform is configured to initiate an authentication process, and wherein the authentication platform is configured to initiate a payment authorization process.

Other embodiments of the invention include a server computer comprising a processor, and a computer readable medium coupled to the processor, the computer readable medium comprising code for implementing a method comprising: providing, by a portable device operated by a user, a transaction initiation request to an authentication platform, wherein the authentication platform was previously verified as an issuer trusted party, wherein the authentication platform is configured to initiate an authentication process, and wherein the authentication platform is configured to initiate a payment authorization process.

Other embodiments of the invention include a method comprising: generating, at an authentication platform, a verify enrollment request message, providing the verify enrollment request message to an issuer computer, receiving a verify enrollment response message, evaluating, by the authentication platform, the verify enrollment response message, wherein the verify enrollment response message further comprises a request for user authentication data, generating a payer authentication request message comprising the requested user authentication data, and providing the payer authentication request message to the issuer computer.

Other embodiments of the invention include a server computer comprising a processor, and a computer readable medium coupled to the processor, the computer readable medium comprising code for implementing a method comprising: generating, at an authentication platform, a verify enrollment request message, providing the verify enrollment request message to an issuer computer, receiving a verify enrollment response message, evaluating, by the authentication platform, the verify enrollment response message, wherein the verify enrollment response message further comprises a request for user authentication data, generating a payer authentication request message comprising the requested user authentication data, and providing the payer authentication request message to the issuer computer.

In some embodiments, instead of having a user use a mobile phone to contact an authentication platform, the user may contact a merchant representative at the merchant, and the merchant's representative may initiate the authentication process through a merchant virtual terminal.

### V. EXEMPLARY APPARATUSES

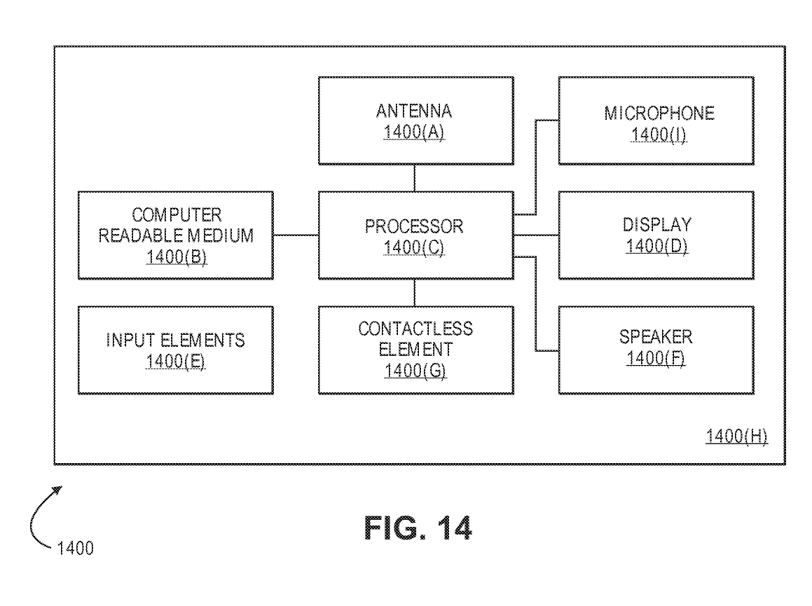

FIG. 14 shows a block diagram of an exemplary portable device 1400. It should be appreciated that portable device 102 and any other portable devices mentioned herein can include some or all of the components of portable device 1400. The exemplary portable device 1400 may comprise a computer-readable medium 1400(B) and a body 1400(H). The computer-readable medium 1400(B) may be present within the body 1400(H), or may be detachable from it. The body 1400(H) may be in the form a plastic substrate, housing, or other structure. The computer-readable medium 1400(B) may be a memory, such as a tangible (i.e. physical or durable) memory that stores data and may be in any suitable form including a hard drive, magnetic stripe, a memory chip, uniquely derived keys (such as those described above), encryption algorithms, etc.

The portable device 1400 may further include a contactless element 1400(G), which is typically implemented in the form of a semiconductor chip (or other data storage element) with an associated wireless transfer (e.g., data transmission) element, such as an antenna 1400(A). Data or control instructions transmitted via a cellular network may be applied to the contactless element 1400(G) by means of a contactless element interface (not shown). The contactless element interface may function to permit the exchange of data and/or control instructions between the portable device circuitry (and hence the cellular network) and an optional contactless element 1400(G).

Contactless element 1400(G) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable device 1400 and an interrogation device. Thus, the portable device 1400 is capable of communicating and transferring data and/or control instructions via both cellular network and near field communications capability.

The portable device 1400 may also include a processor 1400(C) (e.g., a microprocessor or a group of processors working together) for processing the functions of the portable device 1400 and a display 1400(D) to allow a user to send and receive messages with the authentication platform, as well as to view phone numbers and other information and messages. The portable device 1400 may further include input elements 1400(E) to allow a user to input information into the device (e.g. a physical or virtual keyboard), a speaker 1400(F) to allow the user to hear voice communication, music, etc., and a microphone 1400(I) to allow the user to transmit her voice through the portable device 1400. The portable device 1400 may also include an antenna 1400(A) for wireless data transfer (e.g., data transmission).

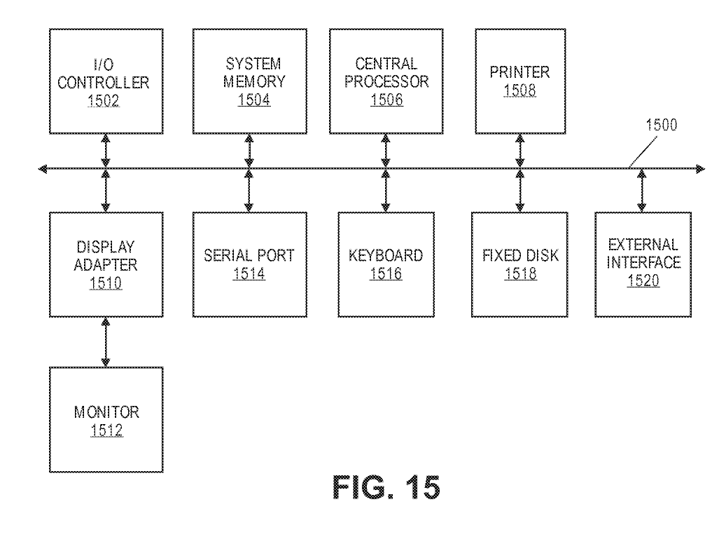

The various participants and elements may operate one or more computer apparatuses (e.g., a server computer) to facilitate the functions described herein. Any of the elements in the figures may use any suitable number of subsystems to facilitate the functions described herein. Examples of such subsystems or components are shown in FIG. 15. The subsystems shown in FIG. 15 are interconnected via a system bus 1500. Additional subsystems such as a printer 1508, keyboard 1516, fixed disk 1518 (or other memory comprising computer readable media), monitor 1512, which is coupled to display adapter 1510, and others are shown. Peripherals and input/output (I/O) devices, which couple to I/O controller 1502, can be connected to the computer system by any number of means known in the art, such as serial port 1514. For example, serial port 1514 or external interface 1520 can be used to connect the computer apparatus to a wide area network such as the Internet, a mouse input device, or a scanner. The interconnection via system bus 1500 allows the central processor 1506 to communicate with each subsystem and to control the execution of instructions from system memory 1504 or the fixed disk 1518, as well as the exchange of information between subsystems. The system memory 1504 and/or the fixed disk 1518 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited in this patent are hereby incorporated by reference for all purposes.

One or more features from any embodiment may be combined with one or more features of any other embodiment without departing from the scope of the disclosure.

In some embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method comprising:
receiving at an authentication platform a transaction initiation request from a portable device operated by a user, wherein the authentication platform was previously verified as an issuer trusted party;
initiating an authentication process by the authentication platform; and
initiating a payment authorization process by the authentication platform.

2. The method of claim 1 wherein the authentication process comprises:
receiving portable device identification data from the portable device;
querying a database with the portable device identification data to determine registration status of the portable device;
generating a user identifier request message;
sending the user identifier request message to the portable device;
receiving a user identifier response message from the portable device; and
verifying the user identifier response message with a user identifier stored in a database.

3. The method of claim 2 wherein the authentication process further comprises:
querying an issuer computer with a verify enrollment request message comprising a token;
receiving, from the issuer computer, a verify enrollment response message, comprising registration status of the portable device and a request for user authentication data;
generating a payer authentication request message comprising the requested user authentication data;
sending, to the issuer computer, the payer authentication request message; and
receiving a payer authentication response message from the issuer computer.

4. The method of claim 3 wherein the token indicates that the authentication platform is an issuer trusted party.

5. The method of claim 4 wherein the verify enrollment request message indicates the type of connection between the authentication platform and the issuer computer.

6. A server computer comprising a processor, and a computer readable medium coupled to the processor, the computer readable medium comprising code for implementing a method comprising:
receiving a transaction initiation request from a portable device operated by a user, wherein the authentication platform was previously verified as an issuer trusted party;
initiating an authentication process by the authentication platform; and
initiating a payment authorization process by the authentication platform.

7. The server computer of claim 6, wherein the authentication process comprises:
receiving portable device identification data from the portable device;
querying a database with the portable device identification data to determine registration status of the portable device;
generating a user identifier request message;
sending the user identifier request message to the portable device;
receiving a user identifier response message from the portable device; and
verifying the user identifier response message with a user identifier stored in a database.

8. The server computer of claim 7, wherein the authentication process comprises:
querying an issuer computer with a verify enrollment request message comprising at least a token;
receiving, from the issuer computer, a verify enrollment response message, comprising registration status of the portable device and a request for user authentication data;
generating a payer authentication request message comprising the requested user authentication data;
sending, to the issuer computer, the payer authentication request message; and
receiving a payer authentication response message from the issuer computer.

9. The server computer of claim 7, wherein the token indicates that the authentication platform is an issuer trusted party.

10. The server computer of claim 9 wherein the verify enrollment request message indicates the type of connection between the authentication platform and the issuer computer.

11. A method comprising:
receiving, from an authentication platform, a verify enrollment request message;
evaluating, by the issuer computer, the verify enrollment request message;
generating a verify enrollment response message in response to the evaluation of the verify enrollment request message, wherein the verify enrollment response message further comprises a request for user authentication data;
receiving, from the authentication platform, a payer authentication request message comprising the requested user authentication data; and
verifying the user authentication data against database user authentication data.

12. The method of claim 11 further comprising:
generating a payer authentication response message based on the verification; and
sending the payer authentication response message to the authentication platform.

13. The method of claim 11 wherein the verify enrollment request message comprises a token, wherein the token indicates the authentication platform as an issuer trusted party.

14. The method of claim 11 wherein the verify enrollment request message comprises portable device identification data indicating the type of portable device being used in the transaction.

15. The method of claim 11 wherein the verify enrollment request message indicates the type of connection between the authentication platform and the issuer computer.

16. The method of claim 13 wherein the payer authentication response message is automatically generated when the token in the verify enrollment request message indicates the authentication platform is issuer trusted.

17. A server computer comprising a processor, and a computer readable medium coupled to the processor, the computer readable medium comprising code for implementing a method comprising:
receiving, from an authentication platform, a verify enrollment request message;
evaluating, by the issuer computer, the verify enrollment request message;
generating a verify enrollment response message in response to the evaluation of the verify enrollment request message, wherein the verify enrollment response message further comprises a request for user authentication data;
receiving, from the authentication platform, a payer authentication request message comprising the requested user authentication data; and
verifying the user authentication data against database user authentication data.

18. The server computer of claim 17 further comprising:
generating a payer authentication response message based on the verification; and
sending the payer authentication response message to the authentication platform.

19. The server computer of claim 17 wherein the verify enrollment request message comprises a token, wherein the token indicates the authentication platform as an issuer trusted party.

20. The server computer of claim 17 wherein the verify enrollment request message comprises portable device identification data indicating the type of portable device being used in the transaction

21. The server computer of claim 17 wherein the verify enrollment message indicates the type of connection between the authentication platform and the issuer computer

22. The server computer of claim 19 wherein the payer authentication response message is automatically generated when the token in the verify enrollment request message indicates the authentication platform is issuer trusted.

23. A method comprising:
receiving, from an authentication platform, a verify enrollment request message;
evaluating, by the issuer computer, the verify enrollment request message;
generating a verify enrollment response message in response to the evaluation of the verify enrollment request message, wherein the verify enrollment response message further comprises data relating to an authentication process used by the issuer computer; and
sending the verify enrollment response message to the authentication platform.

24. The method of claim 23 further comprising:
after sending the verify enrollment response message, sending a request for user identification to a user; and
receiving a response from the user with the user identification.

25. A server computer comprising a processor and a computer readable medium coupled to the processor, the computer readable medium comprising code, executable by the processor for implementing a method comprising:
receiving, from an authentication platform, a verify enrollment request message;
evaluating, by the issuer computer, the verify enrollment request message;
generating a verify enrollment response message in response to the evaluation of the verify enrollment request message, wherein the verify enrollment response message further comprises data relating to an authentication process used by the issuer computer; and
sending the verify enrollment response message to the authentication platform.
